(19) United States
(12) Patent Application Publication
(10) Pub. No.: US 2024/0430887 A1
(43) Pub. Date: Dec. 26, 2024

(54) ENHANCED SIGNALING FOR DISTRIBUTED VIDEO CODING

(71) Applicant: QUALCOMM Incorporated, San Diego, CA (US)

(72) Inventors: Amit BAR-OR TILLINGER, Tel-Aviv (IL); Gideon Shlomo KUTZ, Ramat Hasharon (IL)

(21) Appl. No.: 18/339,503

(22) Filed: Jun. 22, 2023

(51) Int. Cl. H04W 72/1268

(52) U.S. Cl. CPC H04W 72/1268

(57) ABSTRACT

Methods, systems, and devices for wireless communications are described. A user equipment (UE) may transmit multiple data segments of a video frame, where each data segment is mapped to respective physical resources. In some examples, the UE may receive a combined channel state feedback (CCSF) message indicating a predicted quantity of physical resources to successfully decode data segments of one or more video frames subsequent to the video frame. The UE may transmit data segments of the subsequent video frames according to the predicted quantity of physical resources. In some other examples, the UE may receive a segment feedback message associated with data segments that were unsuccessfully decoded by a network entity, where the segment feedback message may indicate a predicted quantity of physical resources to successfully decode the data segments. As such, the UE may retransmit the unsuccessfully decoded data segments according to the predicted quantity of physical resources.

### FIELD OF TECHNOLOGY

The following relates to wireless communications, including enhanced signaling for distributed video coding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhanced signaling for distributed video coding (DVC). For example, the described techniques provide for a user equipment (UE) (e.g., an extended reality (XR) device, a UE configured for offloading some aspects of communications from the XR device) to support reception of feedback messages associated with DVC operations, such that the UE may efficiently perform DVC operations and reduce power consumption. For example, the UE may transmit a message including multiple data segments of a video frame, where each of the multiple data segments may be mapped to a respective physical resource. In response, the UE may receive a combined channel state feedback (CCSF) message based on the transmitted message, where the CCSF message indicates a predicted quantity of physical resources for successful decoding of data segments of subsequent video frames (e.g., future video frames). The indication of the predicted quantity of physical resources may thereby enable the UE to transmit the data segments of the subsequent video frames via a quantity of physical resources that corresponds to the predicted quantity of physical resources associated with successful decoding of the subsequent video frames. As such, the UE may increase the reliability and probability of successful reception of the subsequent video frames based on the CCSF message.

Additionally, or alternatively, the UE may receive a segment feedback message associated with one or more data segments of the video frame that were unsuccessfully decoded at a network entity. In such examples, the segment feedback message may indicate a predicted quantity of physical resources to successfully decode the one or more data segments at the network entity. As such, the UE may retransmit the data segments of the video frame via physical resources that correspond to the predicted quantity of physical resources, thereby increasing the reliability and probability of successful reception of the data segments based on the segment feedback message.

A method for wireless communications at UE is described. The method may include transmitting, via a physical uplink shared channel (PUSCH), a message including a set of multiple data segments of a video frame, each of the set of multiple data segments mapped to a respective physical resource of the PUSCH, receiving, based on transmitting the set of multiple data segments, a CCSF message, the CCSF message including channel state information (CSI) and video state information associated with each of the set of multiple data segments of the video frame, where the CCSF message indicates a predicted quantity of physical resources to successfully decode one or more second video frames, the one or more second video frames being subsequent to the video frame, and transmitting, via the PUSCH, a second set of multiple data segments of the one or more second video frames via a quantity of physical resource, the quantity of physical resources being in accordance with the predicted quantity of physical resources.

A UE for wireless communication is described. The UE may include one or more memories storing processor-executable code and one or more processors coupled with the one or more memories and individually or collectively operable to execute the code to cause the UE to transmit, via a PUSCH, a message including a set of multiple data segments of a video frame, each of the set of multiple data segments mapped to a respective physical resource of the PUSCH, receive, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame, and transmit, via the PUSCH, a second set of multiple data segments of the one or more second video frames via a quantity of physical resource, the quantity of physical resources being in accordance with the predicted quantity of physical resources.

Another UE for wireless communications is described. The UE may include means for transmitting, via a PUSCH, a message including a set of multiple data segments of a video frame, each of the set of multiple data segments mapped to a respective physical resource of the PUSCH, means for receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame, and means for transmitting, via the PUSCH, a second set of multiple data segments of the one or more second video frames via a quantity of physical resource, the quantity of physical resources being in accordance with the predicted quantity of physical resources.

A non-transitory computer-readable medium storing code for wireless communications is described. The code may include instructions executable by one or more processors to transmit, via a PUSCH, a message including a set of multiple data segments of a video frame, each of the set of multiple data segments mapped to a respective physical resource of the PUSCH, receive, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame, and transmit, via the PUSCH, a second set of multiple data segments of the one or more second video frames via a quantity of physical resource, the quantity of physical resources being in accordance with the predicted quantity of physical resources.

Some examples of the method, UEs, and non-transitory computer-readable medium described herein may further include operations, features, means, or instructions for receiving, as part of the CSI of the CCSF message, an indication of one or more physical parameters associated with the predicted quantity of physical resources, where transmitting the second set of multiple data segments may be in accordance with the one or more physical parameters.

In some examples of the method, UEs, and non-transitory computer-readable medium described herein, the one or more physical parameters include a respective rank, a respective modulation and coding scheme (MCS), a respective precoding scheme, or a combination thereof for each physical resource of the predicted quantity of physical resources.

Some examples of the method, UEs, and non-transitory computer-readable medium described herein may further include operations, features, means, or instructions for adjusting the one or more physical parameters and one or more video coding parameters of the second set of multiple data segments based on the CCSF message, where the second set of multiple data segments may be transmitted based on the adjusting.

In some examples of the method, UEs, and non-transitory computer-readable medium described herein, the CCSF message may be received in accordance with a periodicity, semi-persistently, or a combination thereof.

Some examples of the method, UEs, and non-transitory computer-readable medium described herein may further include operations, features, means, or instructions for transmitting the set of multiple data segments of the video frame and reception of the CCSF message may be in accordance with a full duplex mode of operation.

In some examples of the method, UEs, and non-transitory computer-readable medium described herein, each of the set of multiple data segments may be mapped to a respective code block.

A method for wireless communications at a UE is described. The method may include transmitting, via a PUSCH, a message including set of multiple data segments of a video frame to a network entity, each of the set of multiple data segments mapped to a respective physical resource of the PUSCH, receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity, and transmitting, via the PUSCH, a second set of multiple data segments including at least the one or more data segments via a second quantity of physical resources, the second quantity of physical resources being in accordance with the predicted quantity of physical resources.

A UE for wireless communication is described. The UE may include one or more memories storing processor-executable code and one or more processors coupled with the one or more memories and individually or collectively operable to execute the code to cause the UE to transmit, via a PUSCH, a message including set of multiple data segments of a video frame to a network entity, each of the set of multiple data segments mapped to a respective physical resource of the PUSCH, receive, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity, and transmit, via the PUSCH, a second set of multiple data segments including at least the one or more data segments via a second quantity of physical resources, the second quantity of physical resources being in accordance with the predicted quantity of physical resources.

Another UE for wireless communication is described. The UE may include means for transmitting, via a PUSCH, a message including set of multiple data segments of a video frame to a network entity, each of the set of multiple data segments mapped to a respective physical resource of the PUSCH, means for receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity, and means for transmitting, via the PUSCH, a second set of multiple data segments including at least the one or more data segments via a second quantity of physical resources, the second quantity of physical resources being in accordance with the predicted quantity of physical resources.

A non-transitory computer-readable medium storing code for wireless communications is described. The code may include instructions executable by one or more processors to transmit, via a PUSCH, a message including set of multiple data segments of a video frame to a network entity, each of the set of multiple data segments mapped to a respective physical resource of the PUSCH, receive, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity, and transmit, via the PUSCH, a second set of multiple data segments including at least the one or more data segments via a second quantity of physical resources, the second quantity of physical resources being in accordance with the predicted quantity of physical resources.

In some examples of the method, UEs, and non-transitory computer-readable medium described herein, the second quantity of physical resources may be based on a difference between physical resources used for the set of multiple data segments and the predicted quantity of physical resources and the predicted quantity of physical resources may be based on one or more channel conditions of the PUSCH and on video conditions of the video frame.

In some examples of the method, UEs, and non-transitory computer-readable medium described herein, a quantity of bits of the segment feedback message indicating the predicted quantity of physical resources satisfies a threshold quantity of bits.

In some examples of the method, UEs, and non-transitory computer-readable medium described herein, the segment feedback message may be associated with a first data segment of the set of multiple data segments.

In some examples of the method, UEs, and non-transitory computer-readable medium described herein, the segment feedback message may be associated with a group of data segments of the set of multiple data segments.

In some examples of the method, UEs, and non-transitory computer-readable medium described herein, the segment feedback message may be associated with a code block of the PUSCH, and the code block may be associated with a subset of the one or more data segments.

Some examples of the method, UEs, and non-transitory computer-readable medium described herein may further include operations, features, means, or instructions for transmission the set of multiple data segments of the video frame and reception of the segment feedback message may be in accordance with a full duplex mode of operation.

A method for wireless communications at a network entity is described. The method may include receiving, via a PUSCH, a message including a set of multiple data segments of a video frame, each of the set of multiple data segments mapped to a respective physical resource of the PUSCH, transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame, and receiving, via the PUSCH, a second set of multiple data segments of the one or more second video frames via a quantity of physical resources, the quantity of physical resources being in accordance with the predicted quantity of physical resources.

A network entity for wireless communication is described. The network entity may include one or more memories storing processor-executable code and one or more processors coupled with the one or more memories and individually or collectively operable to execute the code to cause the network entity to receive, via a PUSCH, a message including a set of multiple data segments of a video frame, each of the set of multiple data segments mapped to a respective physical resource of the PUSCH, transmit, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame, and receive, via the PUSCH, a second set of multiple data segments of the one or more second video frames via a quantity of physical resources, the quantity of physical resources being in accordance with the predicted quantity of physical resources.

Another network entity for wireless communication is described. The network entity may include means for receiving, via a PUSCH, a message including a set of multiple data segments of a video frame, each of the set of multiple data segments mapped to a respective physical resource of the PUSCH, means for transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame, and means for receiving, via the PUSCH, a second set of multiple data segments of the one or more second video frames via a quantity of physical resources, the quantity of physical resources being in accordance with the predicted quantity of physical resources.

A non-transitory computer-readable medium storing code for wireless communications is described. The code may include instructions executable by one or more processors to receive, via a PUSCH, a message including a set of multiple data segments of a video frame, each of the set of multiple data segments mapped to a respective physical resource of the PUSCH, transmit, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame, and receive, via the PUSCH, a second set of multiple data segments of the one or more second video frames via a quantity of physical resources, the quantity of physical resources being in accordance with the predicted quantity of physical resources.

Some examples of the method, network entities, and non-transitory computer-readable medium described herein may further include operations, features, means, or instructions for transmitting, as part of the CSI of the CCSF message, an indication of one or more physical parameters associated with the predicted quantity of physical resources, where receiving the second set of multiple data segments may be in accordance with the one or more physical parameters.

In some examples of the method, network entities, and non-transitory computer-readable medium described herein, the one or more physical parameters include a respective rank, a respective MCS, a respective precoding scheme, or a combination thereof for each physical resource of the predicted quantity of physical resources.

Some examples of the method, network entities, and non-transitory computer-readable medium described herein may further include operations, features, means, or instructions for calculating the predicted quantity of physical resources associated with the one or more second video frames, where the quantity of physical resources corresponds to the predicted quantity of physical resources.

Some examples of the method, network entities, and non-transitory computer-readable medium described herein may further include operations, features, means, or instructions for calculating first mutual information between respective parity bits of the message and respective transmitted parity bits of the message, calculating second mutual information between respective systematic bits of a set of multiple predicted data segments and respective transmitted systematic bits of the set of multiple data segments, and calculating a quantity of bits of the predicted quantity of physical resources for the set of multiple predicted data segments based on the first mutual information, the second mutual information, a quantity of bits of each data segment of the set of multiple data segments, or a combination thereof, where the predicted quantity of physical resources may be based on the quantity of bits of the predicted quantity of physical resources.

In some examples of the method, network entities, and non-transitory computer-readable medium described herein, each of the set of multiple data segments of the video frame may be associated with a respective prediction quality based on a characteristic of the video frame, and the predicted quantity of physical resources may be based on the respective prediction quality of each of the set of multiple data segments.

In some examples of the method, network entities, and non-transitory computer-readable medium described herein, the CCSF message may be transmitted in accordance with a periodicity, semi-persistently, or a combination thereof.

Some examples of the method, network entities, and non-transitory computer-readable medium described herein may further include operations, features, means, or instructions for receiving the set of multiple data segments of the video frame and transmitting the CCSF message may be in accordance with a full duplex communications mode.

In some examples of the method, network entities, and non-transitory computer-readable medium described herein, the predicted quantity of physical resources may be predicted via one or more machine learning models.

In some examples of the method, network entities, and non-transitory computer-readable medium described herein, each of the set of multiple data segments may be mapped to a respective code block.

A method for wireless communications at a network entity is described. The method may include receiving, via a PUSCH, a message including a set of multiple data segments of a video frame, each of the set of multiple data segments mapped to a respective physical resource of the PUSCH, transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments, and receiving, via the PUSCH, a second set of multiple data segments including at least the one or more data segments via a second quantity of physical resources, the second quantity of physical resources being in accordance with the predicted quantity of physical resources.

A network entity for wireless communication is described. The network entity may include one or more memories storing processor-executable code and one or more processors coupled with the one or more memories and individually or collectively operable to execute the code to cause the network entity to receive, via a PUSCH, a message including a set of multiple data segments of a video frame, each of the set of multiple data segments mapped to a respective physical resource of the PUSCH, transmit, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments, and receive, via the PUSCH, a second set of multiple data segments including at least the one or more data segments via a second quantity of physical resources, the second quantity of physical resources being in accordance with the predicted quantity of physical resources.

Another network entity for wireless communication is described. The network entity may include means for receiving, via a PUSCH, a message including a set of multiple data segments of a video frame, each of the set of multiple data segments mapped to a respective physical resource of the PUSCH, means for transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments, and means for receiving, via the PUSCH, a second set of multiple data segments including at least the one or more data segments via a second quantity of physical resources, the second quantity of physical resources being in accordance with the predicted quantity of physical resources.

A non-transitory computer-readable medium storing code for wireless communications is described. The code may include instructions executable by one or more processors to receive, via a PUSCH, a message including a set of multiple data segments of a video frame, each of the set of multiple data segments mapped to a respective physical resource of the PUSCH, transmit, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments, and receive, via the PUSCH, a second set of multiple data segments including at least the one or more data segments via a second quantity of physical resources, the second quantity of physical resources being in accordance with the predicted quantity of physical resources.

Some examples of the method, network entities, and non-transitory computer-readable medium described herein may further include operations, features, means, or instructions for determining one or more channel conditions of the PUSCH and determining video conditions of the video frame, where the second quantity of physical resources may be based on a difference between physical resources used for the set of multiple data segments and the predicted quantity of physical resources, and where the predicted quantity of physical resources may be based on the one or more channel conditions and the video conditions.

In some examples of the method, network entities, and non-transitory computer-readable medium described herein, a quantity of bits of the segment feedback message indicating the predicted quantity of physical resources satisfies a threshold quantity of bits.

Some examples of the method, network entities, and non-transitory computer-readable medium described herein may further include operations, features, means, or instructions for calculating the predicted quantity of physical resources associated with the one or more data segments.

Some examples of the method, network entities, and non-transitory computer-readable medium described herein may further include operations, features, means, or instructions for calculating first mutual information between respective parity bits of the message and respective transmitted parity bits of the message, calculating second mutual information between respective systemic bits of a set of multiple predicted data segments and respective transmitted systematic bits of the one or more data segments, and calculating a quantity of bits of the predicted quantity of physical resources based on the first mutual information, the second mutual information, a quantity of bits of each data segment of the one or more data segments, or a combination thereof, where the predicted quantity of physical resources may be based on the quantity of bits of the predicted quantity of physical resources.

In some examples of the method, network entities, and non-transitory computer-readable medium described herein, the segment feedback message may be associated with a first data segment of the set of multiple data segments.

In some examples of the method, network entities, and non-transitory computer-readable medium described herein, the segment feedback message may be associated with a group of data segments of the set of multiple data segments.

In some examples of the method, network entities, and non-transitory computer-readable medium described herein, the segment feedback message may be associated with a code block of the PUSCH, and the code block may be associated with a subset of the one or more data segments.

In some examples of the method, network entities, and non-transitory computer-readable medium described herein, reception of the set of multiple data segments of the video frame and transmission of the segment feedback message may be in accordance with a full duplex mode of operation.

In some examples of the method, network entities, and non-transitory computer-readable medium described herein, the predicted quantity of physical resources may be predicted based on one or more machine learning models.

### BRIEF DESCRIPTION OF THE DRAWINGS

FIG. 1 shows an example of a wireless communications system that supports enhanced signaling for distributed video coding (DVC) in accordance with one or more aspects of the present disclosure.

FIG. 2 shows an example of a wireless communications system that supports enhanced signaling for DVC in accordance with one or more aspects of the present disclosure.

FIG. 3 shows an example of a process flow that supports enhanced signaling for DVC in accordance with one or more aspects of the present disclosure.

FIGS. 4 and 5 show block diagrams of devices that support enhanced signaling for DVC in accordance with one or more aspects of the present disclosure.

FIG. 6 shows a block diagram of a communications manager that supports enhanced signaling for DVC in accordance with one or more aspects of the present disclosure.

FIG. 7 shows a diagram of a system including a device that supports enhanced signaling for DVC in accordance with one or more aspects of the present disclosure.

FIGS. 8 and 9 show block diagrams of devices that support enhanced signaling for DVC in accordance with one or more aspects of the present disclosure.

FIG. 10 shows a block diagram of a communications manager that supports enhanced signaling for DVC in accordance with one or more aspects of the present disclosure.

FIG. 11 shows a diagram of a system including a device that supports enhanced signaling for DVC in accordance with one or more aspects of the present disclosure.

FIGS. 12 through 18 show flowcharts illustrating methods that support enhanced signaling for DVC in accordance with one or more aspects of the present disclosure.

### DETAILED DESCRIPTION

In some wireless communications systems, a user equipment (UE) may be intended for, or otherwise implement, one or more extended reality (XR) applications. XR may generally refer to various technologies that include, for example, virtual reality (VR), augmented reality (AR), and mixed reality (MR), to name a few. In such cases, the UE (e.g., an XR device, such as XR glasses, XR goggles, or other type of peripheral device) may be associated with relatively reduced processing power and capabilities. For example, to enable portability, comfort (e.g., for wearable devices), and/or extended usage, some XR devices may be constrained by weight (e.g., battery size and weight), processing complexity, and power consumption, resulting in various challenges, particularly in view of the relatively increased processing demands for some XR applications. As such, due to the relatively high processing associated with XR applications and XR data, and the relatively limited processing capabilities of the UE, the UE may offload data processing to a companion device, such as a network entity (e.g., a UE, gNB, or the like). In one case, the UE and the network entity may perform distributed video coding (DVC), which may enable the UE to offload processing related to encoding of the video frame to the network entity. In DVC, the network entity may use data segments (e.g., bits) of one or more previously received video frames from the UE to predict data segments (e.g., bits) of one or more future video frames, thereby offloading complex video encoding from the UE to the network entity and reducing the quantity of data transmitted from the UE. In such cases, one or more signaling techniques between the UE and the network entity may be desired to support such DVC operations.

The techniques, methods, and devices described herein may enable the network entity to efficiently provide feedback information associated with the DVC operations to the UE, without increasing overhead between the UE and the network entity. For example, the UE may transmit, via a physical uplink shared channel (PUSCH), a message that includes multiple data segments of a video frame, where each data segment of the multiple data segments may be mapped to, or otherwise transmitted via, respective physical resources.

In one example, in response to receiving the message, the network entity may transmit a combined channel state feedback (CCSF) message to the UE that includes both channel state information (CSI) and video state information, where the CCSF message may provide at least an indication of a predicted quantity of physical resources for successful decoding of one or more second (e.g., future) video frames. The network entity may calculate the predicted quantity of physical resources based on previously received video frames and predicted future video frames. Accordingly, the UE may adjust one or more channel parameters (e.g., modulation and coding scheme (MCS), rank, precoding scheme, or the like) based on the CSI of the CCSF message and adjust one or more video coding parameters (e.g., compression parameters, puncturing parameters, or the like) based on the video state information of the CCSF message. The UE may transmit multiple second data segments of the one or more second video frames via a quantity of physical resources that corresponds to the predicted quantity of physical resources. In this way, the UE may transmit data segments associated with one or more future video frames using a quantity of physical resources that corresponds to a predicted quantity of physical resources, thereby increasing the reliability of communications while performing DVC.

In some other examples, the network entity may transmit a segment feedback message associated with one or more data segments of the video frame that were unsuccessfully decoded, where the segment feedback message provides an indication of a predicted quantity of physical resources to successfully decode the one or more data segments. Based on receiving the segment feedback message, the UE may retransmit the one or more data segments (e.g., failed data segments) using a quantity of physical resources that corresponds to the predicted quantity of physical resources. In this way, the UE may receive an indication of, and utilize, the predicted quantity of physical resources to retransmit the unsuccessfully decoded data segments, thereby increasing reliability of the communications between the UE and the network entity during DVC operations.

Aspects of the disclosure are initially described in the context of wireless communications systems. Aspects of the disclosure are further described in the context of a process flow. Aspects of the disclosure are further illustrated by and described with reference to apparatus diagrams, system diagrams, and flowcharts that relate to enhanced signaling for distributed video coding.

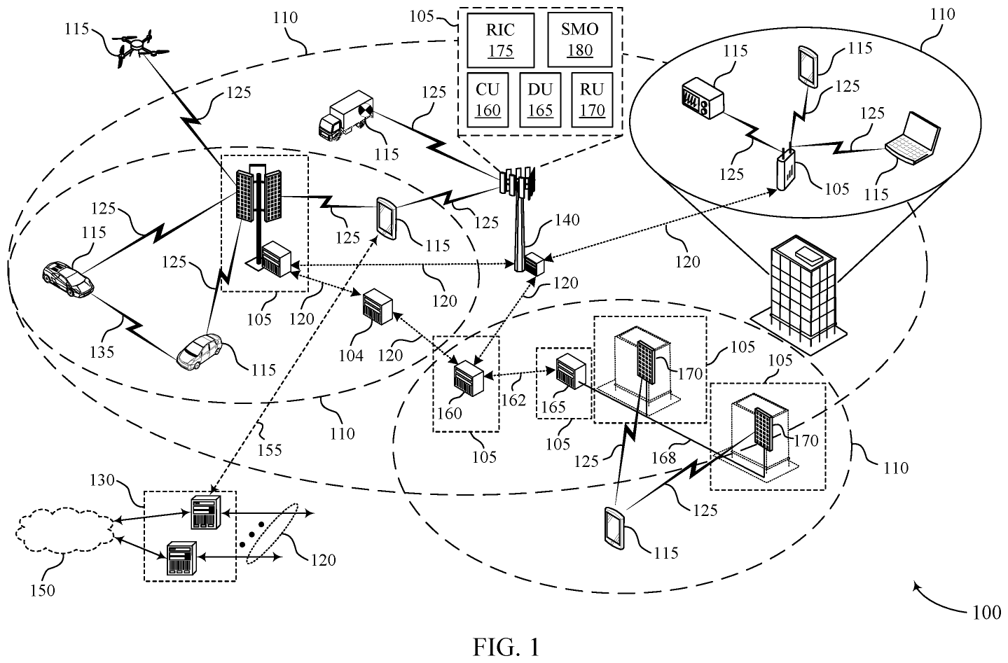

FIG. 1 shows an example of a wireless communications system 100 that supports enhanced signaling for DVC in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support enhanced signaling for DVC as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1. In some aspects, a UE 115 may be an example of a device that supports various XR applications and/or functionalities (e.g., including VR, AR, and/or MR applications and functionalities), and a UE 115 may accordingly be referred to as an XR device, a peripheral device, or some similar terminology.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of physical resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the UE 115 may implement, or otherwise be intended for, XR applications. For example, the UE 115 may be an example of a XR device, such as XR glasses. In such cases, in order for the UE 115 to be available and functional to users, the UE 115 may be associated with relatively lower processing capabilities and relatively lower power consumption metrics (e.g., relative to those of a smartphone, tablet, or other UE 115). In such cases, the UE 115 may offload one or more processes or functions to a companion device, such as the network entity 105 or another UE 115. As an example, a UE 115 may employ a processing/functionality split with another UE 115, and transmit and receive processing complexity (e.g., physical layer-related or modem-related processing) may accordingly be shifted to the other UE 115 via a sidelink communication link. In one case, the UE 115 and the network entity 105 may support DVC, which may enable the UE 115 to offload encoding processes of video frames to the network entity 105, thereby enabling the UE 115 to reduce, or otherwise eliminate, the processing associated with encoding video frames for transmission.

For example, currently, a UE 115 may use a video encoder (e.g., such as an H.264 encoder) to encode a video frame, and the UE 115 may perform channel encoding on the encoded video frame to reduce the effects of channel noise on the data packet. The UE 115 may transmit the encoded video frame via a channel, where the video frame transmission may be influenced by, or otherwise experience, channel noise. The network entity 105 may receive the video frame and perform channel decoding on the video frame to reverse, or otherwise account for, the effects of the channel noise. Based on performing the channel decoding, the network entity 105 may implement a video decoder (e.g., a H.264 decoder) to decode and receive the data of the video frame. In such processes, however, a video encoder at the UE 115 may be relatively complex and incur relatively high-power consumption for the UE 115 (e.g., an XR device, such as XR goggles). Further, the use of a video encoder may introduce an increased amount of latency due to the inherent tradeoff between compression ratio of the video encoder and latency.

As such, to move the complexity from the video encoder to the video decoder, the UE 115 and the network entity 105 may utilize a DVC process. For example, as part of DVC, the UE 115 may deploy a light compression video encoder and a DVC channel encoder to encode the video frame prior to transmission. Based on performing the DVC encoding, the UE 115 may transmit the encoded video to the network entity 105 or another, different UE 115 (e.g., companion device). The network entity 105 may employ a DVC joint channel decoder and video decoder to decode the video frame and receive the data. In this way, the complexity of video encoding may be moved from the UE 115 to the network entity 105 or the other UE 115, thereby reducing power consumption and processing complexity at the UE 115.

As described herein, the components of the DVC operation may include the light compression video encoder at the UE 115, the DVC channel encoder at the UE 115, and the joint DVC channel and video decoder at the network entity 105. The light compression video encoder at the UE 115 (e.g., transmitter side) may be a discrete cosine transform (DCT) based intraframe compression. Such DCT based intraframe compression may be incur relatively low power processing compared to that of the H.264 compression and may be performed on the fly, thereby allowing the UE 115 to eliminate the use of a double data rate (DDR) memory. Further, the UE 115 may perform compression via quantizing and transmitting a subset of the DCT coefficients to the network entity 105, such that the DCT coefficients may be used by the network entity 105 for decoding. The DVC channel encoder at the UE 115 may use a systematic code, such as low-density parity-check (LDPC) codes, to encode the video frame. Further, the UE 115 may perform rate matching (e.g., DVC puncturing) using a DVC puncturing component. For example, for anchor video frames (periodic or after error detection), the UE 115 may perform legacy rate matching. Alternatively, for other video frames, the UE 115 may transmit parity bits in addition to the data of the video frame.

The DVC channel decoder at the network entity 105 or other UE 115 may perform prediction of the received video frame as a priori information of the systematic bits jointly with the received parity bits of the received video frame for detection. For example, as part of the DVC channel decoder, the network entity 105 may implement a high-power prediction component in order to introduce a priori information (e.g., prediction) for the digital decoder, which may be jointly processed with the received (e.g., communicated) information. In some examples, the network entity 105 or another UE 115 may perform DVC de-puncturing in cases when the UE 115 implements DVC puncturing. As such, in DVC operations, the network entity 105 may use one or more previously-received video frames from the UE 115 to predict one or more future video frames, thereby offloading relatively complex video encoding processes from the UE 115 to the network entity 105 or the other UE 115 and reducing the quantity of data transmitted from the UE 115. In such cases, one or more signaling techniques between the UE 115 and the network entity 105 or the other UE 115 may be desired to support such DVC operations.

The techniques, methods, and devices described herein may enable the network entity 105 or another UE 115 to efficiently provide feedback information associated with the DVC operations to the UE 115, without increasing overhead between the UE 115 and the network entity 105 or the other UE 115. For example, the UE 115 may transmit, via a PUSCH, a message that includes multiple data segments of a video frame, where each data segment of the multiple data segments may be mapped to, or otherwise transmitted via, respective physical resources.

In one example, in response to receiving the message, the network entity 105 may transmit a CCSF message to the UE 115 that includes both CSI and video state information, where the CCSF message may provide at least an indication of a predicted quantity of physical resources for successful decoding of one or more second (e.g., future) video frames. In some examples, the network entity 105 may calculate the predicted quantity of physical resources based on mutual information between data of previously received video frames and data of predicted future video frames. Accordingly, the UE 115 may adjust one or more channel parameters (e.g., MCS, rank, precoding scheme, or the like) based on the CSI of the CCSF message and adjust one or more video coding parameters (e.g., compression parameters, puncturing parameters, or the like) based on the video state information of the CCSF message. Further, the UE 115 may transmit multiple data segments of the one or more second video frames via a quantity of physical resources that corresponds to the predicted quantity of physical resources. In this way, the UE 115 may transmit data segments associated with one or more future video frames using a quantity of physical resources that corresponds to a predicted quantity of physical resources, thereby increasing the reliability of communications while performing DVC.

In some other examples, the network entity 105 may transmit a segment feedback message associated with one or more data segments of the video frame that were unsuccessfully decoded, where the segment feedback message provides an indication of a predicted quantity of physical resources to successfully decode the one or more data segments. Based on receiving the segment feedback message, the UE 115 may retransmit the one or more data segments (e.g., failed data segments) using a quantity of physical resources that corresponds to the predicted quantity of physical resources. In this way, the UE 115 may receive an indication of, and utilize, the predicted quantity of physical resources to retransmit the unsuccessfully decoded data segments, thereby increasing reliability of the communications between the UE 115 and the network entity 105 during DVC operations.

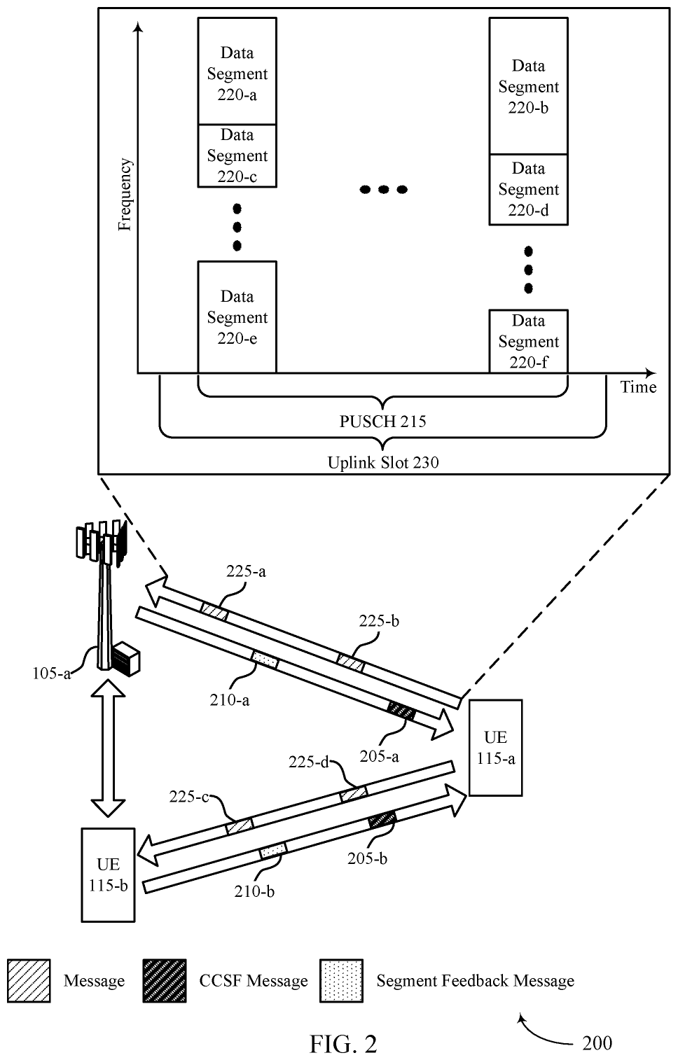

FIG. 2 shows an example of a wireless communications system 200 that supports enhanced signaling for DVC in accordance with one or more aspects of the present disclosure. Aspects of the wireless communications system 200 may implement, or be implemented by, aspects of the wireless communications system 100. For example, the wireless communications system 200 may include a network entity 105-a, a UE 115-a, and a UE 115-b, which may be examples of corresponding devices as described herein. The techniques described in the context of the wireless communications system 200 may enable the UE 115-a to receive and apply one or more feedback messages associated with DVC operations between the UE 115-a and a companion device (e.g., the network entity 105-a, the UE 115-b, or both).

For example, the popularity of VR, AR, and MR technologies (e.g., otherwise known as XR technologies or applications) may be adopted for applications other than gaming, such as healthcare, education, social, retail, or the like. Correspondingly, an increase in demand for XR devices, such as XR goggles, with high quality 3D graphics, higher video resolution, and low-latency capabilities, may be expected. One implementation of such devices may be a lightweight XR device (e.g., the UE 115-a). For example, the UE 115-a (e.g., lightweight XR device) may support high-quality-low-latency video applications, while maintaining a relatively lower power processing (e.g., relative to other devices, such as smartphones, tablets, or the like), by transferring processing of such applications to another device (e.g., a companion device). Such devices may include the UE 115-b, the network entity 105-a, a cloud edge processor at the network entity 105-a, or any combination of devices, nodes, or entities.

To support such high-quality-low-latency video applications, the UE 115-a may support a DVC-based communication scheme that may enable the UE 115-a to reduce computation power as well as memory consumption. For example, as part of DVC operations, the UE 115-a (e.g., transmitting side) and the companion device (e.g., the receiving devices, such as the network entity 105-a, the UE 115-b, or both) may implement a DCT based light compression component. As such, in the DVC scheme, the encoding and decoding of a video may be integrated in the physical layer of the communication system, as opposed to current techniques in which the video encoding and decoding is done at the application layer with minimal interaction with the physical layer. To support such DVC operations, one or more signaling techniques between the UE 115-a and the companion device may be desired.

In accordance with the techniques described herein, the companion device (e.g., the network entity 105-a or the UE 115-b) and the UE 115-a may implement feedback messaging to support DVC operations. For example, in order to efficiently utilize the DVC operations and improve system capacity, the UE 115-a and the companion device may support a CCSF message 205 that includes both CSI and video state information. Using the CCSF message 205, the UE 115-a may be able to jointly adjust both the baseband signaling parameters (e.g., physical parameters, such as MCS, rank, and precoding scheme of the video transmission) and video coding parameters (e.g., such as light compression parameters, puncturing parameters, or the like). Further, in the case of detection failures at the companion device, the UE 115-a and the companion device may support a segment feedback message 210 (e.g., an enhanced soft negative acknowledgment (NACK) message), such that the companion device (e.g., receiver of the video frames) may accurately signal to the UE 115-a (e.g., the transmitter of the video frame) the gap to capacity (e.g., a gap to successful decoding) based on CSI and video state information.

In some examples, the UE 115-a may receive, from the network entity 105-a, a CCSF message 205-a that indicates CSI associated with a PUSCH 215 and video state information associated with multiple data segments 220 (e.g., a data segment 220-a, a data segment 220-b, a data segment 220-c, a data segment 220-d, a data segment 220-e, and a data segment 220-f) of a video frame in response to transmitting a message 225-a (e.g., an uplink message). For example, the UE 115-a may transmit, via the PUSCH 215 during an uplink slot 230, the message 225-a (e.g., an uplink message) that includes multiple data segments 220 of a video frame. In such examples, each data segment 220 may be mapped to different physical resources (e.g., resource blocks, resource elements, or the like) of the PUSCH 215.

As described herein, a data segment 220 may include one or more systematic bits (e.g., data bits) of a video frame and one or more parity bits, where such parity bits may be generated, or otherwise calculated, by the channel encoder (e.g., LDPC encoder). Further, a physical resource may refer to a set of time and frequency resources (e.g., resource elements) via which the UE 115-a may transmit each data segment 220. As such, each data segment 220 may be associated with a respective quantity of bits (e.g., both systematic and parity) that indicate a portion of the video frame, and the UE 115-a may transmit each data segment via respective quantities of physical resources based on the quantity of bits for the portion of the video frame captured in each data segment 220.

As an illustrative example, the data segment 220-a may include a first quantity of bits of the video frame and be mapped to a first quantity of physical resources. Similarly, the data segment 220-b may be associated with a second quantity of bits of the video frame, where the second quantity of bits may be greater than that of the first quantity of bits associated with the data segment 220-a. In such examples, due to the data segment 220-b having a relatively increased quantity of bits relative to those of the data segment 220-a, the UE 115-a may use an increased quantity of physical resources (e.g., increased quantity of time or frequency resources) to transmit the data segment 220-b relative to those used to transmit the data segment 220-a. In this way, the UE 115-a may transmit each data segment 220 according to the quantity of bits included in each data segment 220. In some examples, each data segment may be mapped to one or more code blocks.

Further, each data segment may be associated with a different prediction quality at the network entity 105-a (e.g., receiver) due to different characteristics (e.g., movement, color, or the like) of the video frame. As an illustrative example, one or more data segments 220 of the video frame transmitted via the message 225-a may capture movement (e.g., motion of a video) relative to data segments 220 a previous video frame. As such, the data segments 220 that capture such movement may have a decreased or lower prediction quality relative to data segments 220 that are static or the same as a previous video frame of the video. As such, each data segment 220-a may have a respective prediction quality based on the characteristics of the video frame. In some examples, the network entity 105-a may use such prediction qualities in order to predict future video frames, calculate a predicted quantity of physical resources for the predicted future video frames, or both.

In response to receiving the message 225-a, for each data segment 220 of the video frame, the network entity 105-a (e.g., the receiver) may calculate a predicted quantity of physical resources to successfully decode multiple data segments 220 of one or more second video frames, where such second video frames may be subsequent in time to the video frame received via the message 225-a. That is, the network entity 105-a may calculate a respective predicted quantity of physical resources based on each received data segment 220, where the respective predicted quantity of physical resources may be used by the UE 115-a to transmit data segments 220 of future video frames. In some examples, the network entity 105-a may use the prediction qualities of each data segment 220 in order to predict future video frames, calculate the predicted quantity of physical resources for the predicted future video frames, or both.

Further, for each data segment 220 of the video frame, the network entity 105-a may calculate respective physical parameters associated with physical resources that are to be used to transmit the data segments 220 of future video frames. Such physical parameters may include a MCS, a rank, a precoding transmission scheme, or a combination thereof. As such, in addition to calculating a respective predicted quantity of physical resources based on each data segment 220 of the video frame received via the message 225-a, the network entity 105-a may also determine, or otherwise identify, physical parameters for each data segment 220 of one or more future video frames.

In some examples, the network entity 105-a may calculate the respective predicted quantity of physical resources using one or more machine learning techniques. In one example, the network entity 105-a may calculate the predicted quantity of physical resources using a quantity of physical resources used for the message 225-a and mutual information between received bits (e.g., parity and systematic) of the message 225-a (e.g., observed signal) and the transmitted bits (e.g., parity and systematic) of the message 225-a (e.g., the desired signal). The network entity 105-a, for example, may use Equation 1 to calculate numerical mutual information (e.g., I(x;y)) using a set of probabilities per bit (e.g., pᵢ⁰ and pᵢ¹), where x represents the transmitted bits of the message 225-a (e.g., the desired signal) and y represents the received bits of the message 225-a (e.g., the observed signal):

$$I ( x ; y ) = \frac{1}{N} {\sum }_{i = 0}^{N - 1} ( {p}_{i}^{0} * {log}_{2} ( 2 * {p}_{i}^{0} ) + {p}_{i}^{1} * {log}_{2} ( 2 * {p}_{i}^{1} ) ) \qquad ( 1 )$$

As such, for each data segment 220, the network entity 105-a may calculate first mutual information (e.g., M_{Rec}), per bit of each data segment 220, between the received parity bits of each data segment 220 and the transmitted parity bits of each data segment 220. Such first mutual information may indicate the quantity of parity bits that may be communicated via the PUSCH 215. Further, for each data segment 220, the network entity 105-a may calculate second mutual information (e.g., M_{Pred}), per bit of each data segment 220, between predicted systematic bits of each predicted data segment 220 of a future video frame and the transmitted light compression output systematic bits of each data segment 220. As such, using the first mutual information (e.g., M_{Rec}), the second mutual information (e.g., M_{Pred}), and the quantity of physical resources (e.g., in bits) used for each data segment 220 (e.g., N bits), the network entity 105-a may calculate the predicted quantity of physical resources (e.g., represented in a quantity of bits) for each data segment 220 using Equation 2:

$$N * \frac{( 1 - {M}_{Pred} )}{{M}_{Rec}} \qquad ( 2 )$$

As an illustrative example, to calculate the predicted quantity of physical resources for a future data segment 220 that corresponds to the data segment 220-a, the network entity 105-a may calculate, per bit of the data segment 220-a, first mutual information between the received parity bits of the data segment 220-a (e.g., the observed bits) and the transmitted parity bits of the data segment 220-a (e.g., the desired bits) using Equation 1. Further, the network entity 105-a may calculate, per bit of the data segment 220-a and the future data segment 220, second mutual information between the predicted systematic bits of the future data segment 220 (e.g., desired bits) and the received (e.g., compressed output) systematic bits of the data segment 220-a (e.g., observed bits) using Equation 1. As such, based on calculating the first mutual information and the second mutual information, the network entity 105-a may calculate a predicted quantity of physical resources for the future data segment 220 that corresponds to the data segment 220-b based on the first mutual information, the second mutual information, and the quantity of physical resources (e.g., in bits) used to transmit the data segment 220-a using Equation 2. The network entity 105-a may perform this process for each data segment 220 of the video frame received via the message 225-a.

Based on calculating the predicted quantity of physical resources and determining the physical parameters (e.g., MCS, rank, precoding scheme, or the like) for each data segment 220 of one or more future video frames (e.g., second video frames), the network entity 105-a may transmit the CCSF message 205-a to the UE 115-a. That is, the network entity 105-a (e.g., the receiver of the video frames) may report, via the CCSF message 205-a, to the UE 115-a (e.g., the transmitter of the video frames) per data segment 220 or per group of data segments 220 the predicted quantity of physical resources and associated physical parameters. In such examples, the network entity 105-a may transmit the CCSF message 205-a according to a periodicity or semi-statically. Further, in some examples, the network entity 105-a may transmit the CCSF message 205-a in a full duplex operation, such that the network entity 105-a may simultaneously receive the message 225-a via the PUSCH 215, calculate the predicted quantity of physical resources and determine the physical parameters, and transmit the CCSF message 205-a.

As described herein, the network entity 105-a may indicate respective physical parameters for each of the respective predicted quantity of physical resources via the CSI portion of the CCSF message 205-a. Further, the network entity 105-a may indicate the respective predicted quantity of physical resources via the video state information portion of the CCSF message 205-a. In response to receiving the CCSF message 205-a, the UE 115-a may jointly adjust both physical parameters (e.g., MCS, rank, precoding) in accordance with the CSI of the CCSF message 205-a and the video coding parameters (e.g., light compression parameters, puncturing parameters, or the like) in accordance with the video state information of the CCSF message 205-a.

Based on adjusting the parameters, the UE 115-a may transmit, via the PUSCH 215, a message 225-b that includes multiple data segments 220 of second video frames. In such examples, the second video frames may be subsequent in time to the video frame transmitted via the message 225-a. Additionally, the UE 115-a may transmit the multiple data segments 220 in accordance with the indication of the predicted quantity of physical resources received via the CCSF message 205-a. That is, the UE 115-a may transmit the multiple data segments 220 via a quantity of physical resources that corresponds to predicted quantity of physical resources indicated via the CCSF message 205-a, thereby increasing the reliability of communications while performing DVC.

In some other examples, in response to transmitting the message 225-a, the UE 115-a may receive the segment feedback message 210-a due to unsuccessful decoding of one or more data segments 220 at the network entity 105-a. That is, in the case of decoding failure at the network entity 105-a, the network entity 105-a may transmit the segment feedback message 210-a (e.g., soft-NACK) indicating a predicted quantity of physical resources (e.g., gap to successful decoding) for retransmission of one or more unsuccessfully decoded data segments 220. In such examples, the network entity 105-a may refrain from transmitting current acknowledgment (ACK) or NACK signaling (e.g., which includes a pass or fail indication per transport block). In such examples, because the data segments 220 may be mapped to respective code blocks, the network entity 105-a may unsuccessfully decode one or more code blocks of the message 225-a. Alternatively, the network entity 105-a may fail to decode a group of data segments 220.

As such, for each failed code block, failed data segment 220, or failed group of data segments 220, the network entity 105-a may calculate a predicted quantity of physical resources (e.g., a quantity of additional resources) for successful decoding of the one or more failed code blocks, failed data segments 220, or failed group of data segments 220. In such examples, the network entity 105-a may calculate the predicted quantity of physical resources considering both the channel conditions (e.g., signal-to-noise ratio (SNR), signal-to-interference and noise ratio (SINR), or the like) of the PUSCH 215 in addition to one or more video conditions (e.g., quantity of information for successful decoding). In some examples, the network entity 105-a may perform such calculations using machine learning techniques.

In one example, the network entity 105-a may calculate the predicted quantity of physical resources for successful decoding of one or more data segments 220 using a quantity of physical resources used for each failed data segment 220, a quantity of bits for each failed data segment 220, and mutual information between received bits (e.g., parity and systematic) of each failed data segment 220 (e.g., observed signal) and the transmitted bits (e.g., parity and systematic) of each failed data segment 220 (e.g., the desired signal). The network entity 105-a may use Equation 1 described herein to calculate such numerical mutual information.

As such, for each failed data segment 220, the network entity 105-a may calculate first mutual information (e.g., M_{Rec}), per bit, between the received parity bits of each failed data segment 220 and the transmitted parity bits of each failed data segment 220. Further, for each failed data segment 220, the network entity 105-a may calculate second mutual information (e.g., M_{Pred}), per bit, between the predicted systematic bits of a predicted data segment of a future video frame and the transmitted light compression output systematic bits of the failed data segment. As such, using the first mutual information (e.g., M_{Rec}), the second mutual information (e.g., M_{Pred}), the quantity of bits used for each data segment 220 (e.g., N bits), and the quantity of physical resources used for the message 225-a (e.g., N₁), the network entity 105-a may calculate the predicted quantity of physical resources (e.g., represented in a quantity of bits) for each failed data segment 220 using Equation 3:

$${N}_{ReTX} = N * \frac{( 1 - {M}_{Pred} )}{{M}_{Rec}} - {N}_{1} * {M}_{Rec} \qquad ( 3 )$$

As an illustrative example, the network entity 105-a may fail to decode the data segment 220-a. As such, to calculate the predicted quantity of physical resources for retransmission of the data segment 220-a, the network entity 105-a may calculate, per bit of the data segment 220-a, first mutual information between the received parity bits of the data segment 220-a (e.g., the observed bits) and the transmitted parity bits of the data segment 220-a (e.g., the desired bits) using Equation 1. Further, the network entity 105-a may calculate, per bit of the data segment 220-a and the predicted retransmission of the data segment 220-a, second mutual information between the predicted systematic bits of the retransmission of the data segment 220-a (e.g., desired bits) and the received (e.g., compressed output) systematic bits of the data segment 220-a (e.g., observed bits) using Equation 1. As such, based on calculating the first mutual information and the second mutual information, the network entity 105-a may calculate a predicted quantity of physical resources for the retransmission of data segment 220-a based on the first mutual information, the second mutual information, the quantity of bits associated with the data segment 220-a (e.g., N), and the quantity of physical resources used for the message 225-a (e.g., N₁) using Equation 3. The network entity 105-a may perform this process for each failed data segment 220, failed code block, or failed group of data segments 220 of the video frame received via the message 225-a.

Based on calculating the predicted quantity of physical resources for each failed data segment 220, failed code block, or failed group of data segments 220, the network entity 105-a may transmit an indication of the predicted quantity of physical resources via the segment feedback message 210-a. In order to reduce overhead, the network entity 105-a may quantize the indication of the predicted quantity of physical resources to satisfy a threshold quantity of bits. For example, the network entity 105-a may transmit the indication of the predicted quantity of physical resources using a quantity of bits (e.g., a resolution) that satisfies the threshold quantity of bits. Further, in some examples, the network entity 105-a may transmit the segment feedback message 210-a in a full duplex operation, such that the network entity 105-a may simultaneously receive the message 225-a via the PUSCH 215, calculate the predicted quantity of physical resources, and transmit the segment feedback message 210-a.

In some examples, the network entity 105-a may transmit respective segment feedback messages 210 per code block, per data segment 220, or per group of data segments 220. As an illustrative example, if the data segments 220 of the video frame are split into four code blocks and two code blocks were unsuccessfully decoded, the network entity 105-a may transmit a first segment feedback message 210 indicating a first predicted quantity of physical resources for a first failed code block and transmit a second segment feedback message 210 indicating a second predicted quantity of physical resources for a second failed code block. Similarly, the network entity 105-a may transmit respective segment feedback messages 210 per failed data segment 220 or per failed group of data segments 220.

Based on receiving the segment feedback message 210-a, the UE 115-a may retransmit the one or more failed data segments 220 via the message 225-b using a quantity of physical resources that corresponds to the indicated predicted quantity of physical resources. The network entity 105-a may use the retransmission of the one or more failed data segments 220 in combination with the received data segments via the message 225-a to successfully decode and receive the video frame.

As an illustrative example, the UE 115-a may transmit the data segments 220 of the video frame via 100 resource elements. The network entity 105-a may fail to decode one or more of the data segments 220 and may also predict that 50 resource elements (e.g., gap to successful decoding may be 50 resource elements) may be used for retransmission of the failed data segments 220.

In some examples, the network entity 105-a may indicate, via the segment feedback message 210-a, that 50 resource elements may be used for retransmission of one or more failed data segments 220. That is, the network entity 105-a may transmit the difference (e.g., gap to successful decoding) between the quantity of physical resources used for the message 225-b and the quantity of physical resources used for the message 225-a.

In some other examples, the network entity 105-a may indicate, via the segment feedback message 210-a, that 150 resource elements may be used to successfully decode the data segments 220 of the message 225-a. As such, because the UE 115-a transmitted the message 225-a with 100 resource elements, the UE 115-a may determine that 50 resource elements (e.g., 150−100=50) may be used for retransmission of the one or more failed data segments 220.

In response, the UE 115-a may retransmit, via the 50 resource elements, the one or more failed data segments 220 (e.g., with different parity bits) in the message 225-b. As such, the network entity 105-a may receive retransmission of the one or more failed data segments 220 and use a combination of both the message 225-a and the message 225-b to decode the video frame. That is, the network entity 105-a may jointly process the data segments 220 received via the message 225-a and the message 225-b to successfully decode the video frame.

In some examples, the UE 115-a may perform the techniques described herein with a companion device such as the UE 115-b. For example, the UE 115-c may transmit, to the UE 115-b via a physical sidelink shared channel (PSSCH), a message 225-c that includes the multiple data segments 220 of the video frame. If the UE 115-b successfully decodes each data segment 220, then the UE 115-b may calculate a predicted quantity of physical resources for transmission of one or more future video frames and determine one or more physical parameters associated with each of the predicted quantity of physical resources as described herein. The UE 115-b may indicate the predicted quantity of physical resources via video state information of a CCSF message 205-b and indicate the one or more physical parameters as part of CSI information of the CCSF message 205-b.

In response to receiving the CCSF message 205-b, the UE 115-a may jointly adjust both physical parameters (e.g., MCS, rank, precoding) in accordance with the CSI of the CCSF message 205-b and the video coding parameters (e.g., light compression parameters, puncturing parameters, or the like) in accordance with the video state information of the CCSF message 205-b.

Based on adjusting the parameters, the UE 115-a may transmit, via the PSSCH, a message 225-d that includes multiple data segments 220 of second video frames. In such examples, the second video frames may be subsequent in time to the video frame transmitted via the message 225-c. Additionally, the UE 115-a may transmit the multiple data segments 220 in accordance with the indication of the predicted quantity of physical resources received via the CCSF message 205-b. That is, the UE 115-a may transmit the multiple data segments 220 via a quantity of physical resources that corresponds to predicted quantity of physical resources indicated via the CCSF message 205-b, thereby increasing the reliability of communications while performing DVC.

Additionally, or alternatively, if the UE 115-b fails to decode one or more data segments 220, the UE 115-b may calculate a predicted quantity of physical resources to successfully decode the one or more failed data segments 220. In such examples, the UE 115-b may calculate the predicted quantity of physical resources according to the techniques described herein. Based on calculating the predicted quantity of physical resources, the UE 115-b may indicate the predicted quantity of physical resources to the UE 115-a via the segment feedback message 210-b.

Based on receiving the segment feedback message 210-b, the UE 115-a may retransmit the one or more failed data segments 220 via the message 225-d using a quantity of physical resources that corresponds to the indicated predicted quantity of physical resources. The UE 115-b may use the retransmission of the one or more failed data segments 220 in combination with the received data segments via the message 225-c to successfully decode and receive the video frame.

In some examples, a UE 115 (e.g., the UE 115-a, the UE 115-b) may transmit CCSF messages, the segment feedback messages, or both, to another device in accordance with one or more aspects described herein. For instance, the UE 115-a may be a device with some processing capabilities and/or functionality that enable the UE 115-a to determine the information for inclusion in one or both of a CCSF message 225 or a segment feedback message 210, and transmission thereof (e.g., to the UE 115-b, to the network entity 105-a). As such, the described examples of the UE 115-a receiving a CCSF message 225 and/or a segment feedback message 210 should not be considered limiting to the scope of the claims or the disclosure.

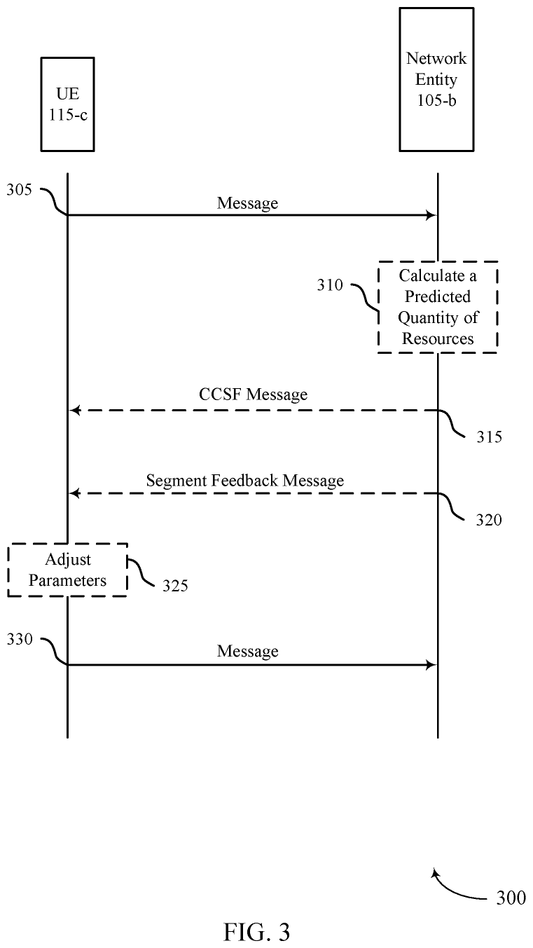

FIG. 3 shows an example of a process flow 300 that supports enhanced signaling for DVC in accordance with one or more aspects of the present disclosure. Aspects of the process flow 300 may implement, or be implemented by, aspects of the wireless communications system 100 and the wireless communications system 200. For example, the process flow 300 may include a UE 115-c, which may be an example of a UE 115-a as described herein. Further, the process flow 300 may include a network entity 105-b, which may be an example of a network entity 105-a or a UE 115-b as described herein. The techniques described in the context of the process flow 300 may enable the network entity 105-b to provide feedback messages to the UE 115-c during DVC operations.

In the following description of the process flow 300, the operations between the network entity 105-b and the UE 115-c may be performed in a different order than the example order shown, or the respective operations performed by the network entity 105-b and the UE 115-c may be performed in different orders or at different times. Some operations may be omitted from the process flow 300, and other operations may be added to the process flow 300.

At 305, the UE 115-c may transmit, via a physical channel (e.g., such as a such as a PUSCH 215 or a PSSCH), a message (e.g., such as a message 225-a or a message 225-c) that includes multiple data segments (e.g., such as data segments 220) of a video frame, where each of the multiple data segments may be mapped to a respective physical resource of the physical channel. In some examples, each of the data segments may be mapped to a respective code block (e.g., a group of physical resources).

At 310, the network entity 105-b may calculate a predicated quantity of physical resources based on receiving the message at 305. In one example, the network entity 105-b may calculate a predicted quantity of physical resources to successfully decode multiple second data segments of one or more second video frames, where the second video frames are subsequent to the video frame received at 305. That is, based on receiving and decoding the multiple data segments of the video frame, the network entity 105-b may calculate a predicted quantity of physical resources for transmission of multiple data segments of one or more future video frames by the UE 115-c.

In another example, based on receiving the multiple data segments of the video frame at 305, the network entity 105-b may unsuccessfully decode (e.g., fail to decode) one or more data segments of the video frame. In such examples, the network entity 105-b may calculate a predicted quantity of physical resources to successfully decode the one or more unsuccessfully decoded data segments.

In some examples, each of the multiple data segments of the video frame received at 305 may be associated with a respective prediction quality based on a characteristic of the video frame (e.g., whether the video frame includes increased movement relative to a previous video frame). As such, the network entity 105-b may calculate the predicted quantity of physical resources based on the respective prediction quality of each of the plurality of data segments. Further, in some examples, the network entity 105-b may calculate the predicted quantity of physical resources based on channel conditions of the physical channel between the UE 115-c and the network entity 105-b, one or more video state conditions (e.g., a quantity of data included in the one or more data segments), or both.

To calculate the predicted quantity of physical resources, the network entity 105-b may use one or more machine learning models. As an illustrative example, the network entity 105-b may calculate the predicted quantity of physical resources based on mutual information. For example, the network entity 105-b may calculate first mutual information between respective parity bits of the message and respective transmitted parity bits of the message. The network entity 105-b may calculate second mutual information between respective systematic bits of a plurality of data segments and respective transmitted systematic bits of the one or more data segments. Based on the first mutual, the second mutual information, a quantity of bits of each data segment, or a combination thereof, the network entity 105-b may calculate a quantity of bits of the predicted quantity of physical resources, where the predicted quantity of physical resources may be based on the calculated quantity of bits.

At 315, in some examples, the network entity 105-b may transmit a CCSF message that includes both CSI and video state information associated with of the multiple data segments. In such examples, the video state information of the CCSF message may indicate the predicted quantity of physical resources to successfully decode the one or more second video frames, where the predicted quantity of physical resources may be calculated according to the techniques described at 310. In some examples, the network entity 105-b may simultaneously receive the message at 305 and transmit the CCSF message at 315 in accordance with a full-duplex mode of operation. The network entity 105-b may transmit the CCSF message in accordance with a periodicity, semi-persistently, or aperiodically. Further, the network entity 105-b may include, as part of the CSI of the CCSF message, one or more physical parameters associated with the predicted quantity of physical resources, such as a respective rank, a respective MCS, or a respective precoding scheme for each physical resource of the predicted quantity of physical resources.

Additionally, or alternatively, at 320, the network entity 105-b may transmit a segment feedback message associated with one or more data segments of the multiple of data segments that were unsuccessfully decoded at the network entity 105-b. In such examples, the segment feedback message may indicate the predicted quantity of physical resources to successfully decode the one or more data segments based on performing the calculations at 310. In some examples, the network entity 105-b may receive the message at 305 and transmit the segment feedback message at 320 simultaneously in accordance with a full-duplex mode of operation.

In such examples, the network entity 105-b may indicate the predicated quantity of physical resources via a quantity of bits that satisfies a threshold quantity of bits. That is, in order to reduce overhead in the segment feedback message, the network entity 105-b may quantize the indication of the predicted quantity of physical resources of the segment feedback message to satisfy the threshold quantity of bits.

In some examples, the network entity 105-b may transmit a respective segment feedback message indicating a predicted quantity of physical resources for each failed data segment of the one or more data segments that were unsuccessfully decoded. Alternatively, the network entity 105-b may transmit a first segment feedback message for a group of failed data segments and a second segment feedback message for a second group of failed data segments. In some other examples, the network entity 105-b may transmit a respective segment feedback message per code block of the transmission of the message at 305, where each code block may be associated with a subset of the one or more data segments unsuccessfully decoded by the network entity 105-b.

At 325, in response to receiving the CCSF message at 315, receiving the segment feedback message at 320, or both, the UE 115-c may adjust one or more transmission parameters. For example, the UE 115-c may adjust the one or more physical parameters and one or more video coding parameters of multiple second data segments of one or more future video frames based on the CCSF. Additionally, or alternatively, the UE 115-c may adjust a quantity of physical resources associated with retransmission of the one or more failed data segments based on the indicated predicted quantity of physical resources.

At 330, the UE 115-c may transmit, via a second message (e.g., such as the message 225-b and the message 225-d) the multiple data segments of the one or more second (future) video frames via a quantity of physical resources and according to the one or more transmission parameters indicated via the CCSF message. In such examples, the quantity of physical resources may correspond to the predicted quantity of physical resources indicated via the CCSF message. Additionally, or alternatively, the UE 115-c may retransmit the one or more failed data segments via a quantity of physical resources that corresponds to the predicted quantity of physical resources indicated via the segment feedback message. That is, in such examples (e.g., failed data segments), the predicted quantity of physical resources may be based on, or otherwise represent, a difference between physical resources used for the multiple of data segments received via the message at 305 and the predicted quantity of physical resources.

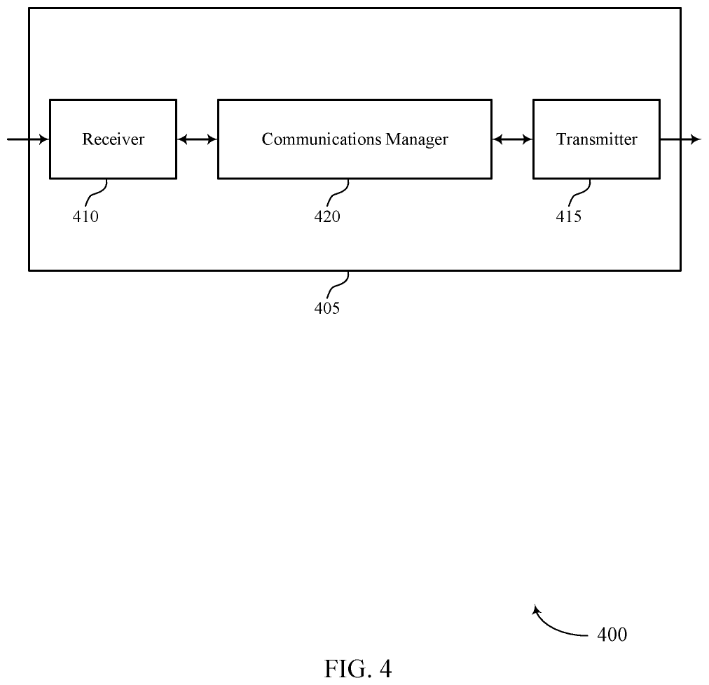

FIG. 4 shows a block diagram 400 of a device 405 that supports enhanced signaling for DVC in accordance with one or more aspects of the present disclosure. The device 405 may be an example of aspects of a UE 115 as described herein. The device 405 may include a receiver 410, a transmitter 415, and a communications manager 420. The device 405 may also include one or more processors. Each of these components may be in communication with one another (e.g., via one or more buses).

The receiver 410 may provide a means for receiving information such as packets, user data, control information, or any combination thereof associated with various information channels (e.g., control channels, data channels, information channels related to enhanced signaling for DVC). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to enhanced signaling for DVC). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of enhanced signaling for DVC as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include one or more processors, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, one or more processors and one or more memories coupled with the one or more processors may be configured to perform one or more of the functions described herein (e.g., by executing, by the one or more processors, instructions stored in the one or more memories).

Additionally, or alternatively, in some examples, the communications manager 420, the receiver 410, the transmitter 415, or various combinations or components thereof may be implemented in code (e.g., as communications management software or firmware) executed by one or more processors. If implemented in code executed by one or more processors, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for transmitting, via a physical uplink shared channel, a message including a set of multiple data segments of a video frame, each of the set of multiple data segments mapped to a respective physical resource of the physical uplink shared channel. The communications manager 420 is capable of, configured to, or operable to support a means for receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. The communications manager 420 is capable of, configured to, or operable to support a means for transmitting, via the physical uplink shared channel, a second set of multiple data segments of the one or more second video frames via a quantity of physical resource, the quantity of physical resources being in accordance with the predicted quantity of physical resources.

Additionally, or alternatively, the communications manager 420 may support wireless communications at a UE in accordance with examples as disclosed herein. For example, the communications manager 420 is capable of, configured to, or operable to support a means for transmitting, via a physical uplink shared channel, a message including set of multiple data segments of a video frame to a network entity, each of the set of multiple data segments mapped to a respective physical resource of the physical uplink shared channel. The communications manager 420 is capable of, configured to, or operable to support a means for receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity. The communications manager 420 is capable of, configured to, or operable to support a means for transmitting, via the physical uplink shared channel, a second set of multiple data segments including at least the one or more data segments via a second quantity of physical resources, the second quantity of physical resources being in accordance with the predicted quantity of physical resources.

By including or configuring the communications manager 420 in accordance with examples as described herein, the device 405 (e.g., one or more processors controlling or otherwise coupled with the receiver 410, the transmitter 415, the communications manager 420, or a combination thereof) may support techniques for a UE to receive CCSF and segment feedback for video frames in a DVC scheme, resulting in reduced processing, reduced power consumption, and more efficient utilization of communication resources.

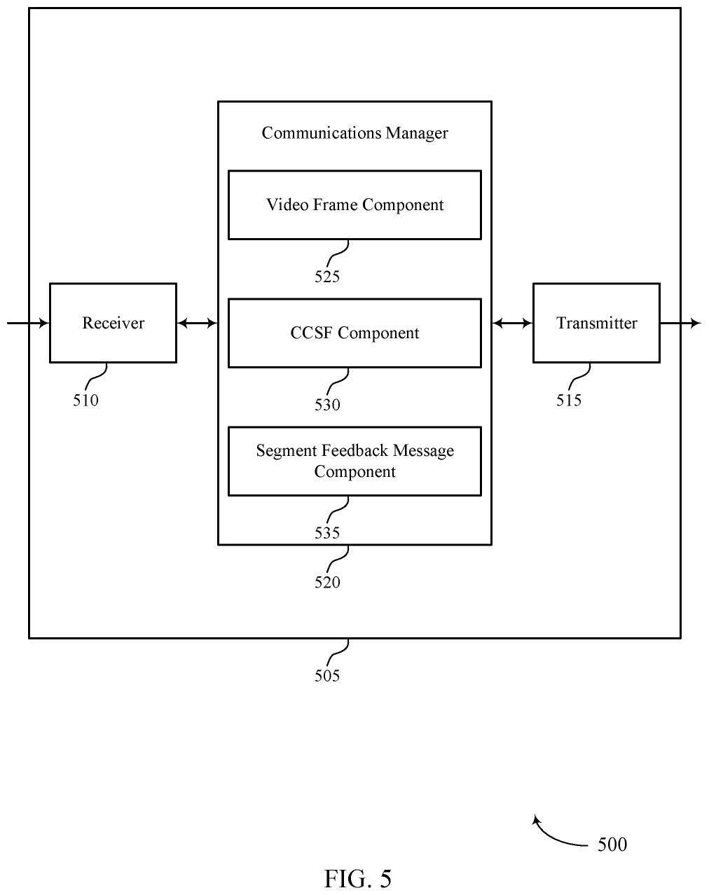

FIG. 5 shows a block diagram 500 of a device 505 that supports enhanced signaling for DVC in accordance with one or more aspects of the present disclosure. The device 505 may be an example of aspects of a device 405 or a UE 115 as described herein. The device 505 may include a receiver 510, a transmitter 515, and a communications manager 520. The device 505 may also include one or more processors. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced signaling for DVC). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced signaling for DVC). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of enhanced signaling for DVC as described herein. For example, the communications manager 520 may include a video frame component 525, an CCSF component 530, a segment feedback message component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The video frame component 525 is capable of, configured to, or operable to support a means for transmitting, via a physical uplink shared channel, a message including a set of multiple data segments of a video frame, each of the set of multiple data segments mapped to a respective physical resource of the physical uplink shared channel. The CCSF component 530 is capable of, configured to, or operable to support a means for receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. The video frame component 525 is capable of, configured to, or operable to support a means for transmitting, via the physical uplink shared channel, a second set of multiple data segments of the one or more second video frames via a quantity of physical resource, the quantity of physical resources being in accordance with the predicted quantity of physical resources.

Additionally, or alternatively, the communications manager 520 may support wireless communications at a UE in accordance with examples as disclosed herein. The video frame component 525 is capable of, configured to, or operable to support a means for transmitting, via a physical uplink shared channel, a message including set of multiple data segments of a video frame to a network entity, each of the set of multiple data segments mapped to a respective physical resource of the physical uplink shared channel. The segment feedback message component 535 is capable of, configured to, or operable to support a means for receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity. The video frame component 525 is capable of, configured to, or operable to support a means for transmitting, via the physical uplink shared channel, a second set of multiple data segments including at least the one or more data segments via a second quantity of physical resources, the second quantity of physical resources being in accordance with the predicted quantity of physical resources.

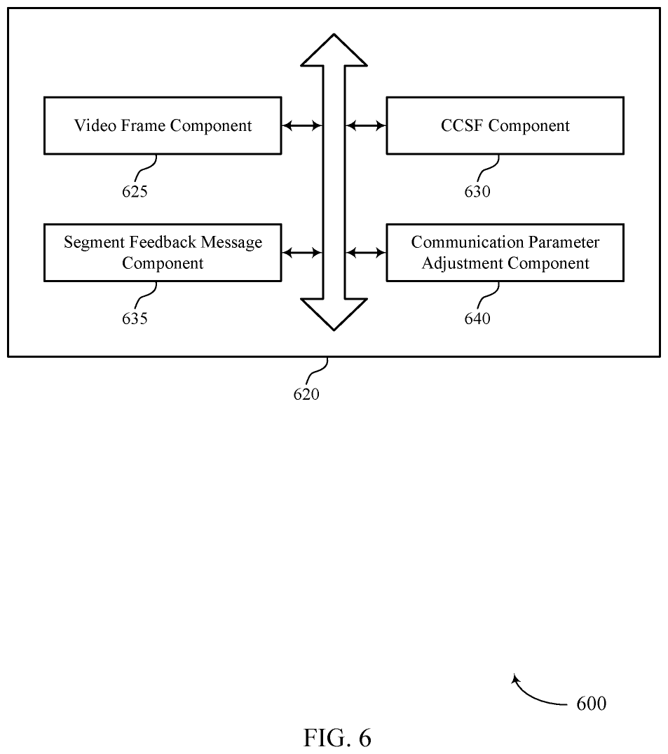

FIG. 6 shows a block diagram 600 of a communications manager 620 that supports enhanced signaling for DVC in accordance with one or more aspects of the present disclosure. The communications manager 620 may be an example of aspects of a communications manager 420, a communications manager 520, or both, as described herein. The communications manager 620, or various components thereof, may be an example of means for performing various aspects of enhanced signaling for DVC as described herein. For example, the communications manager 620 may include a video frame component 625, an CCSF component 630, a segment feedback message component 635, a communication parameter adjustment component 640, or any combination thereof. Each of these components may communicate, directly or indirectly, with one another (e.g., via one or more buses).

The communications manager 620 may support wireless communications at a UE in accordance with examples as disclosed herein. The video frame component 625 is capable of, configured to, or operable to support a means for transmitting, via a physical uplink shared channel, a message including a set of multiple data segments of a video frame, each of the set of multiple data segments mapped to a respective physical resource of the physical uplink shared channel. The CCSF component 630 is capable of, configured to, or operable to support a means for receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. In some examples, the video frame component 625 is capable of, configured to, or operable to support a means for transmitting, via the physical uplink shared channel, a second set of multiple data segments of the one or more second video frames via a quantity of physical resource, the quantity of physical resources being in accordance with the predicted quantity of physical resources.

In some examples, the CCSF component 630 is capable of, configured to, or operable to support a means for receiving, as part of the CSI of the CCSF message, an indication of one or more physical parameters associated with the predicted quantity of physical resources, where transmitting the second set of multiple data segments is in accordance with the one or more physical parameters.

In some examples, the one or more physical parameters include a respective rank, a respective MCS, a respective precoding scheme, or a combination thereof for each physical resource of the predicted quantity of physical resources.

In some examples, the communication parameter adjustment component 640 is capable of, configured to, or operable to support a means for adjusting the one or more physical parameters and one or more video coding parameters of the second set of multiple data segments based on the CCSF message, where the second set of multiple data segments are transmitted based on the adjusting.

In some examples, the CCSF message is received in accordance with a periodicity, semi-persistently, or a combination thereof.

In some examples, transmitting the set of multiple data segments of the video frame and reception of the CCSF message is in accordance with a full duplex mode of operation.

In some examples, each of the set of multiple data segments is mapped to a respective code block.

Additionally, or alternatively, the communications manager 620 may support wireless communications at a UE in accordance with examples as disclosed herein. In some examples, the video frame component 625 is capable of, configured to, or operable to support a means for transmitting, via a physical uplink shared channel, a message including set of multiple data segments of a video frame to a network entity, each of the set of multiple data segments mapped to a respective physical resource of the physical uplink shared channel. The segment feedback message component 635 is capable of, configured to, or operable to support a means for receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity. In some examples, the video frame component 625 is capable of, configured to, or operable to support a means for transmitting, via the physical uplink shared channel, a second set of multiple data segments including at least the one or more data segments via a second quantity of physical resources, the second quantity of physical resources being in accordance with the predicted quantity of physical resources.

In some examples, the predicted quantity of physical resources is based on a difference between physical resources used for the set of multiple data segments and the predicted quantity of physical resources. In some examples, the predicted quantity of physical resources is based on one or more channel conditions of the physical uplink shared channel and on video conditions of the video frame.

In some examples, a quantity of bits of the segment feedback message indicating the predicted quantity of physical resources satisfies a threshold quantity of bits.

In some examples, the segment feedback message is associated with a first data segment of the set of multiple data segments.

In some examples, the segment feedback message is associated with a group of data segments of the set of multiple data segments.

In some examples, the segment feedback message is associated with a code block of the physical uplink shared channel. In some examples, the code block is associated with a subset of the one or more data segments.

In some examples, transmission the set of multiple data segments of the video frame and reception of the segment feedback message is in accordance with a full duplex mode of operation.

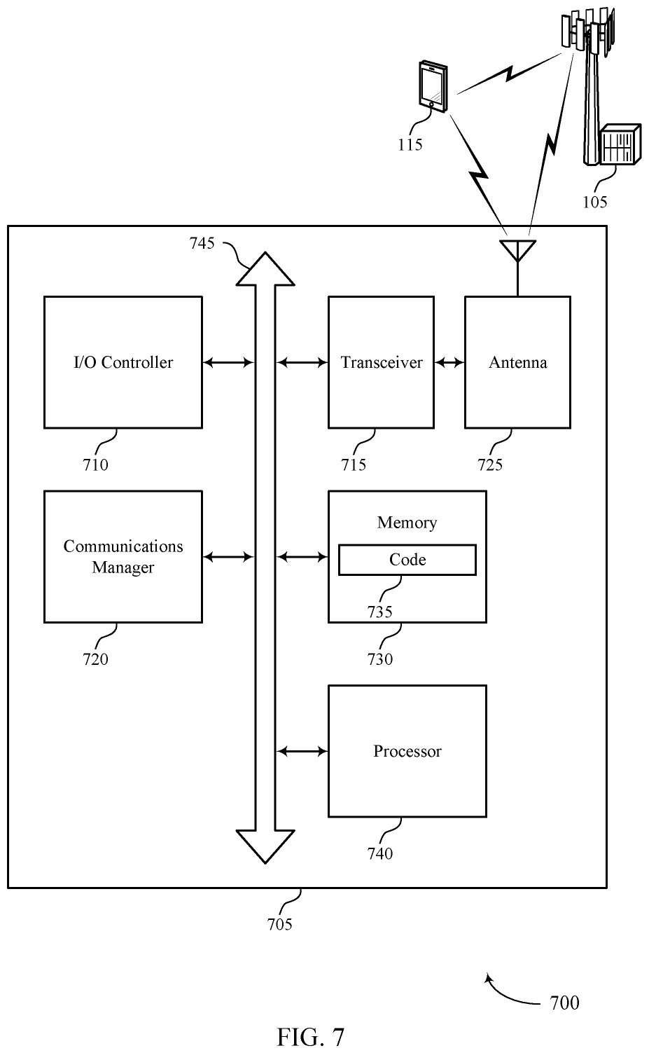

FIG. 7 shows a diagram of a system 700 including a device 705 that supports enhanced signaling for DVC in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745). In some examples, the device 705 may include one or more processors 740 and one or more memories 730 configured to perform the aspects described herein.

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting enhanced signaling for DVC). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 is capable of, configured to, or operable to support a means for transmitting, via a physical uplink shared channel, a message including a set of multiple data segments of a video frame, each of the set of multiple data segments mapped to a respective physical resource of the physical uplink shared channel. The communications manager 720 is capable of, configured to, or operable to support a means for receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. The communications manager 720 is capable of, configured to, or operable to support a means for transmitting, via the physical uplink shared channel, a second set of multiple data segments of the one or more second video frames via a quantity of physical resource, the quantity of physical resources being in accordance with the predicted quantity of physical resources.

Additionally, or alternatively, the communications manager 720 may support wireless communications at a UE in accordance with examples as disclosed herein. For example, the communications manager 720 is capable of, configured to, or operable to support a means for transmitting, via a physical uplink shared channel, a message including set of multiple data segments of a video frame to a network entity, each of the set of multiple data segments mapped to a respective physical resource of the physical uplink shared channel. The communications manager 720 is capable of, configured to, or operable to support a means for receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity. The communications manager 720 is capable of, configured to, or operable to support a means for transmitting, via the physical uplink shared channel, a second set of multiple data segments including at least the one or more data segments via a second quantity of physical resources, the second quantity of physical resources being in accordance with the predicted quantity of physical resources.

By including or configuring the communications manager 720 in accordance with examples as described herein, the device 705 may support techniques for a UE to receive CCSF and segment feedback for video frames in a DVC scheme, resulting in reduced processing, reduced power consumption, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of enhanced signaling for DVC as described herein, or the processor 740 and the memory 730 may be otherwise configured to perform or support such operations.

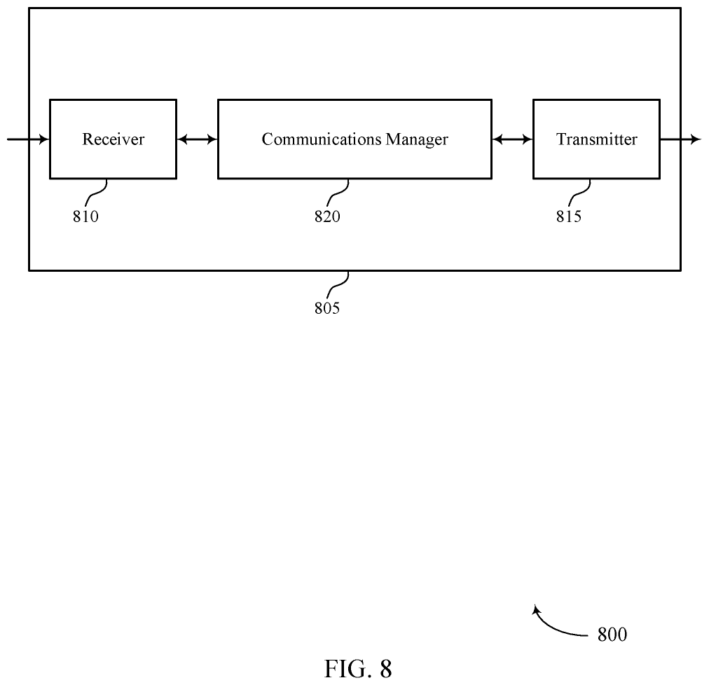

FIG. 8 shows a block diagram 800 of a device 805 that supports enhanced signaling for DVC in accordance with one or more aspects of the present disclosure. The device 805 may be an example of aspects of a network entity 105 as described herein. The device 805 may include a receiver 810, a transmitter 815, and a communications manager 820. The device 805 may also include one or more processors. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of enhanced signaling for DVC as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include one or more processors, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, one or more processors and one or more memories coupled with the one or more processors may be configured to perform one or more of the functions described herein (e.g., by executing, by the one or more processors, instructions stored in the one or more memories).

Additionally, or alternatively, in some examples, the communications manager 820, the receiver 810, the transmitter 815, or various combinations or components thereof may be implemented in code (e.g., as communications management software or firmware) executed by one or more processors. If implemented in code executed by one or more processors, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 is capable of, configured to, or operable to support a means for receiving, via a physical uplink shared channel, a message including a set of multiple data segments of a video frame, each of the set of multiple data segments mapped to a respective physical resource of the physical uplink shared channel. The communications manager 820 is capable of, configured to, or operable to support a means for transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame. The communications manager 820 is capable of, configured to, or operable to support a means for receiving, via the physical uplink shared channel, a second set of multiple data segments of the one or more second video frames via a quantity of physical resources, the quantity of physical resources being in accordance with the predicted quantity of physical resources.

Additionally, or alternatively, the communications manager 820 may support wireless communications at a network entity in accordance with examples as disclosed herein. For example, the communications manager 820 is capable of, configured to, or operable to support a means for receiving, via a physical uplink shared channel, a message including a set of multiple data segments of a video frame, each of the set of multiple data segments mapped to a respective physical resource of the physical uplink shared channel. The communications manager 820 is capable of, configured to, or operable to support a means for transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments. The communications manager 820 is capable of, configured to, or operable to support a means for receiving, via the physical uplink shared channel, a second set of multiple data segments including at least the one or more data segments via a second quantity of physical resources, the second quantity of physical resources being in accordance with the predicted quantity of physical resources.

By including or configuring the communications manager 820 in accordance with examples as described herein, the device 805 (e.g., one or more processors controlling or otherwise coupled with the receiver 810, the transmitter 815, the communications manager 820, or a combination thereof) may support techniques for a UE to receive CCSF and segment feedback for video frames in a DVC scheme, resulting in reduced processing at the UE, reduced power consumption at the UE, and more efficient utilization of communication resources.

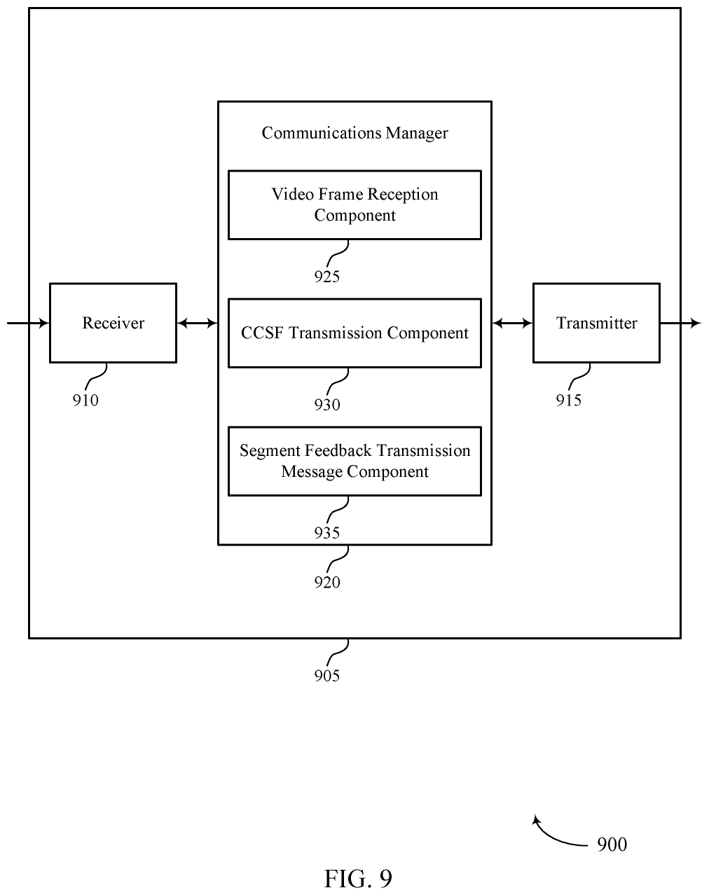

FIG. 9 shows a block diagram 900 of a device 905 that supports enhanced signaling for DVC in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include one or more processors. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of enhanced signaling for DVC as described herein. For example, the communications manager 920 may include a video frame reception component 925, an CCSF transmission component 930, a segment feedback transmission message component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The video frame reception component 925 is capable of, configured to, or operable to support a means for receiving, via a physical uplink shared channel, a message including a set of multiple data segments of a video frame, each of the set of multiple data segments mapped to a respective physical resource of the physical uplink shared channel. The CCSF transmission component 930 is capable of, configured to, or operable to support a means for transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame. The video frame reception component 925 is capable of, configured to, or operable to support a means for receiving, via the physical uplink shared channel, a second set of multiple data segments of the one or more second video frames via a quantity of physical resources, the quantity of physical resources being in accordance with the predicted quantity of physical resources.

Additionally, or alternatively, the communications manager 920 may support wireless communications at a network entity in accordance with examples as disclosed herein. The video frame reception component 925 is capable of, configured to, or operable to support a means for receiving, via a physical uplink shared channel, a message including a set of multiple data segments of a video frame, each of the set of multiple data segments mapped to a respective physical resource of the physical uplink shared channel. The segment feedback transmission message component 935 is capable of, configured to, or operable to support a means for transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments. The video frame reception component 925 is capable of, configured to, or operable to support a means for receiving, via the physical uplink shared channel, a second set of multiple data segments including at least the one or more data segments via a second quantity of physical resources, the second quantity of physical resources being in accordance with the predicted quantity of physical resources.

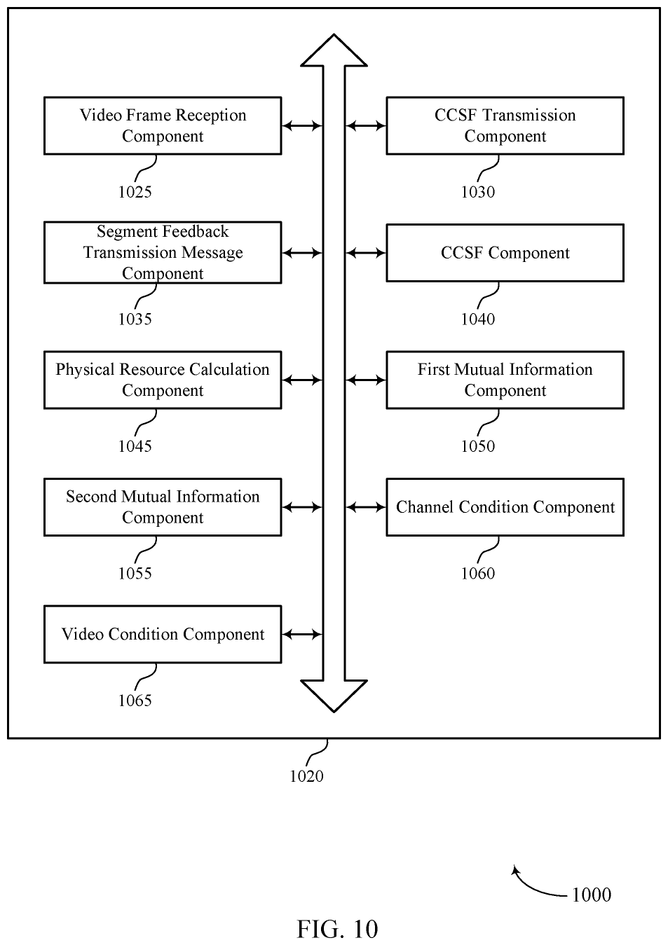

FIG. 10 shows a block diagram 1000 of a communications manager 1020 that supports enhanced signaling for DVC in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of enhanced signaling for DVC as described herein. For example, the communications manager 1020 may include a video frame reception component 1025, an CCSF transmission component 1030, a segment feedback transmission message component 1035, an CCSF component 1040, a physical resource calculation component 1045, a first mutual information component 1050, a second mutual information component 1055, a channel condition component 1060, a video condition component 1065, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The video frame reception component 1025 is capable of, configured to, or operable to support a means for receiving, via a physical uplink shared channel, a message including a set of multiple data segments of a video frame, each of the set of multiple data segments mapped to a respective physical resource of the physical uplink shared channel. The CCSF transmission component 1030 is capable of, configured to, or operable to support a means for transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame. In some examples, the video frame reception component 1025 is capable of, configured to, or operable to support a means for receiving, via the physical uplink shared channel, a second set of multiple data segments of the one or more second video frames via a quantity of physical resources, the quantity of physical resources being in accordance with the predicted quantity of physical resources.

In some examples, the CCSF component 1040 is capable of, configured to, or operable to support a means for transmitting, as part of the CSI of the CCSF message, an indication of one or more physical parameters associated with the predicted quantity of physical resources, where receiving the second set of multiple data segments is in accordance with the one or more physical parameters.

In some examples, the one or more physical parameters include a respective rank, a respective MCS, a respective precoding scheme, or a combination thereof for each physical resource of the predicted quantity of physical resources.

In some examples, the physical resource calculation component 1045 is capable of, configured to, or operable to support a means for calculating the predicted quantity of physical resources associated with the one or more second video frames, where the quantity of physical resources corresponds to the predicted quantity of physical resources.

In some examples, the first mutual information component 1050 is capable of, configured to, or operable to support a means for calculating first mutual information between respective parity bits of the message and respective transmitted parity bits of the message. In some examples, the second mutual information component 1055 is capable of, configured to, or operable to support a means for calculating second mutual information between respective systematic bits of a set of multiple predicted data segments and respective transmitted systematic bits of the set of multiple data segments. In some examples, the physical resource calculation component 1045 is capable of, configured to, or operable to support a means for calculating a quantity of bits of the predicted quantity of physical resources for the set of multiple predicted data segments based on the first mutual information, the second mutual information, a quantity of bits of each data segment of the set of multiple data segments, or a combination thereof, where the predicted quantity of physical resources is based on the quantity of bits of the predicted quantity of physical resources.

In some examples, each of the set of multiple data segments of the video frame is associated with a respective prediction quality based on a characteristic of the video frame, and the predicted quantity of physical resources is based on the respective prediction quality of each of the set of multiple data segments.

In some examples, the CCSF message is transmitted in accordance with a periodicity, semi-persistently, or a combination thereof.

In some examples, receiving the set of multiple data segments of the video frame and transmitting the CCSF message is in accordance with a full duplex communications mode.

In some examples, the predicted quantity of physical resources are predicted via one or more machine learning models.

In some examples, each of the set of multiple data segments is mapped to a respective code block.

Additionally, or alternatively, the communications manager 1020 may support wireless communications at a network entity in accordance with examples as disclosed herein. In some examples, the video frame reception component 1025 is capable of, configured to, or operable to support a means for receiving, via a physical uplink shared channel, a message including a set of multiple data segments of a video frame, each of the set of multiple data segments mapped to a respective physical resource of the physical uplink shared channel. The segment feedback transmission message component 1035 is capable of, configured to, or operable to support a means for transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments. In some examples, the video frame reception component 1025 is capable of, configured to, or operable to support a means for receiving, via the physical uplink shared channel, a second set of multiple data segments including at least the one or more data segments via a second quantity of physical resources, the second quantity of physical resources being in accordance with the predicted quantity of physical resources.

In some examples, the channel condition component 1060 is capable of, configured to, or operable to support a means for determining one or more channel conditions of the physical uplink shared channel. In some examples, the video condition component 1065 is capable of, configured to, or operable to support a means for determining video conditions of the video frame, where the predicted quantity of physical resources is based on a difference between physical resources used for the set of multiple data segments and the predicted quantity of physical resources, and where the predicted quantity of physical resources is based on the one or more channel conditions and the video conditions.

In some examples, a quantity of bits of the segment feedback message indicating the predicted quantity of physical resources satisfies a threshold quantity of bits.

In some examples, the physical resource calculation component 1045 is capable of, configured to, or operable to support a means for calculating the predicted quantity of physical resources associated with the one or more data segments.

In some examples, the first mutual information component 1050 is capable of, configured to, or operable to support a means for calculating first mutual information between respective parity bits of the message and respective transmitted parity bits of the message. In some examples, the second mutual information component 1055 is capable of, configured to, or operable to support a means for calculating second mutual information between respective systemic bits of a set of multiple predicted data segments and respective transmitted systematic bits of the one or more data segments. In some examples, the physical resource calculation component 1045 is capable of, configured to, or operable to support a means for calculating a quantity of bits of the predicted quantity of physical resources based on the first mutual information, the second mutual information, a quantity of bits of each data segment of the one or more data segments, or a combination thereof, where the predicted quantity of physical resources is based on the quantity of bits of the predicted quantity of physical resources.

In some examples, the segment feedback message is associated with a first data segment of the set of multiple data segments.

In some examples, the segment feedback message is associated with a group of data segments of the set of multiple data segments.

In some examples, the segment feedback message is associated with a code block of the physical uplink shared channel. In some examples, the code block is associated with a subset of the one or more data segments.

In some examples, reception of the set of multiple data segments of the video frame and transmission of the segment feedback message is in accordance with a full duplex mode of operation.

In some examples, the predicted quantity of physical resources are predicted based on one or more machine learning models.

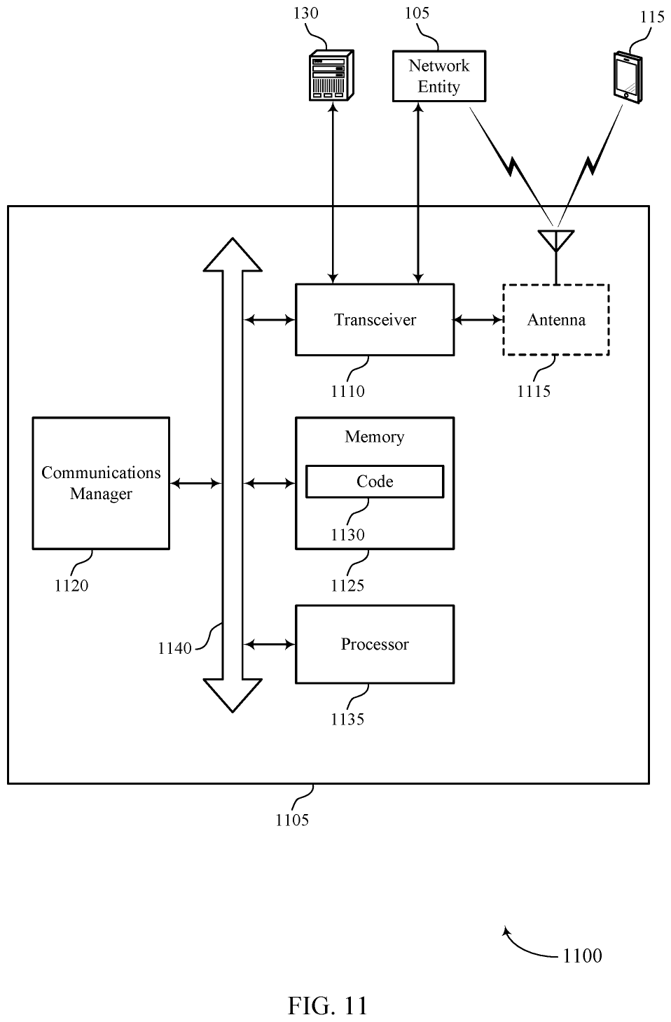

FIG. 11 shows a diagram of a system 1100 including a device 1105 that supports enhanced signaling for DVC in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140). In some examples, the device 1105 may include one or more processors 1135 and one or more memories 1125 configured to perform the aspects described herein.

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting enhanced signaling for DVC). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 is capable of, configured to, or operable to support a means for receiving, via a physical uplink shared channel, a message including a set of multiple data segments of a video frame, each of the set of multiple data segments mapped to a respective physical resource of the physical uplink shared channel. The communications manager 1120 is capable of, configured to, or operable to support a means for transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame. The communications manager 1120 is capable of, configured to, or operable to support a means for receiving, via the physical uplink shared channel, a second set of multiple data segments of the one or more second video frames via a quantity of physical resources, the quantity of physical resources being in accordance with the predicted quantity of physical resources.

Additionally, or alternatively, the communications manager 1120 may support wireless communications at a network entity in accordance with examples as disclosed herein. For example, the communications manager 1120 is capable of, configured to, or operable to support a means for receiving, via a physical uplink shared channel, a message including a set of multiple data segments of a video frame, each of the set of multiple data segments mapped to a respective physical resource of the physical uplink shared channel. The communications manager 1120 is capable of, configured to, or operable to support a means for transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments. The communications manager 1120 is capable of, configured to, or operable to support a means for receiving, via the physical uplink shared channel, a second set of multiple data segments including at least the one or more data segments via a second quantity of physical resources, the second quantity of physical resources being in accordance with the predicted quantity of physical resources.

By including or configuring the communications manager 1120 in accordance with examples as described herein, the device 1105 may support techniques for a UE to receive CCSF and segment feedback for video frames in a DVC scheme, resulting in reduced processing at the UE, reduced power consumption at the UE, and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of enhanced signaling for DVC as described herein, or the processor 1135 and the memory 1125 may be otherwise configured to perform or support such operations.

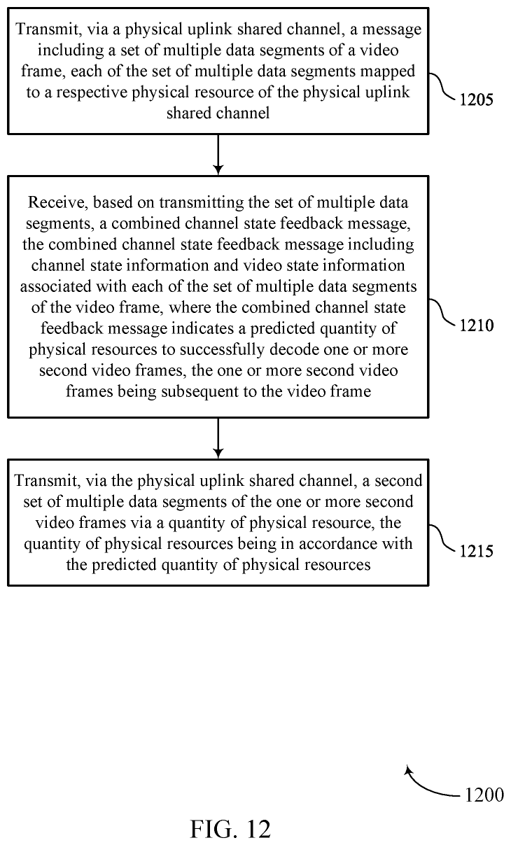

FIG. 12 shows a flowchart illustrating a method 1200 that supports enhanced signaling for DVC in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting, via a physical uplink shared channel, a message including a set of multiple data segments of a video frame, each of the set of multiple data segments mapped to a respective physical resource of the physical uplink shared channel. The operations of 1205 may be performed in accordance with examples as disclosed herein. In some examples, aspects of the operations of 1205 may be performed by a video frame component 625 as described with reference to FIG. 6.

At 1210, the method may include receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. The operations of 1210 may be performed in accordance with examples as disclosed herein. In some examples, aspects of the operations of 1210 may be performed by an CCSF component 630 as described with reference to FIG. 6.

At 1215, the method may include transmitting, via the physical uplink shared channel, a second set of multiple data segments of the one or more second video frames via a quantity of physical resource, the quantity of physical resources being in accordance with the predicted quantity of physical resources. The operations of 1215 may be performed in accordance with examples as disclosed herein. In some examples, aspects of the operations of 1215 may be performed by a video frame component 625 as described with reference to FIG. 6.

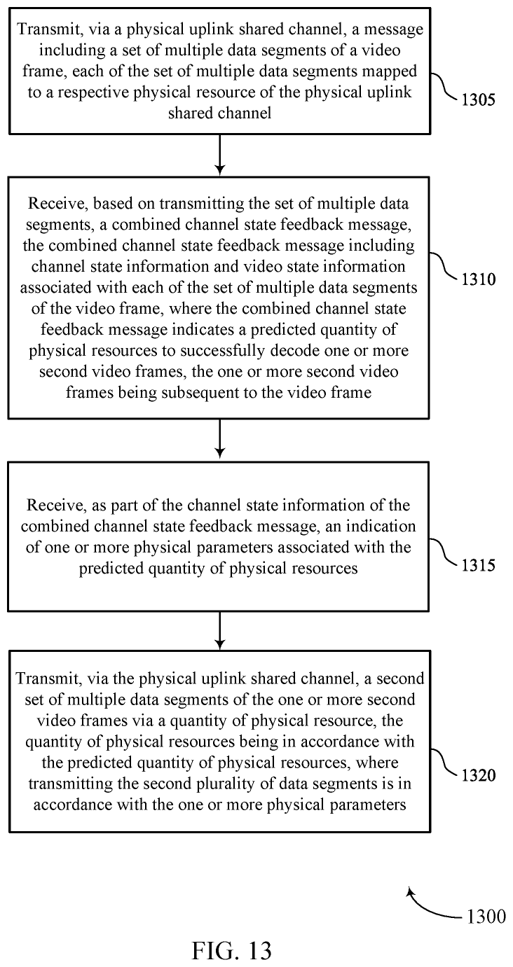

FIG. 13 shows a flowchart illustrating a method 1300 that supports enhanced signaling for DVC in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting, via a physical uplink shared channel, a message including a set of multiple data segments of a video frame, each of the set of multiple data segments mapped to a respective physical resource of the physical uplink shared channel. The operations of 1305 may be performed in accordance with examples as disclosed herein. In some examples, aspects of the operations of 1305 may be performed by a video frame component 625 as described with reference to FIG. 6.

At 1310, the method may include receiving, based on transmitting the set of multiple data segments, a CCSF message, the CCSF message including CSI and video state information associated with each of the set of multiple data segments of the video frame, where the CCSF message indicates a predicted quantity of physical resources to successfully decode one or more second video frames, the one or more second video frames being subsequent to the video frame. The operations of 1310 may be performed in accordance with examples as disclosed herein. In some examples, aspects of the operations of 1310 may be performed by an CCSF component 630 as described with reference to FIG. 6.

At 1315, the method may include receiving, as part of the channel state information of the combined channel state feedback message, an indication of one or more physical parameters associated with the predicted quantity of physical resources. The operations of 1315 may be performed in accordance with examples as disclosed herein. In some examples, aspects of the operations of 1315 may be performed by an CCSF component 630 as described with reference to FIG. 6.

At 1320, the method may include transmitting, via the physical uplink shared channel, a second set of multiple data segments of the one or more second video frames via a quantity of physical resource, the quantity of physical resources being in accordance with the predicted quantity of physical resources, where transmitting the second set of multiple data segments is in accordance with the one or more physical parameters associated with the predicted quantity of physical resources. The operations of 1320 may be performed in accordance with examples as disclosed herein. In some examples, aspects of the operations of 1320 may be performed by a video frame component 625 as described with reference to FIG. 6.

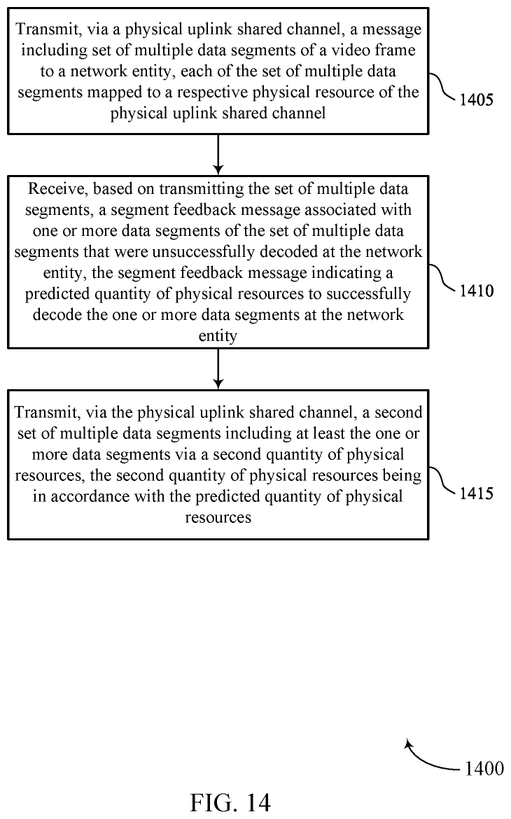

FIG. 14 shows a flowchart illustrating a method 1400 that supports enhanced signaling for DVC in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include transmitting, via a physical uplink shared channel, a message including set of multiple data segments of a video frame to a network entity, each of the set of multiple data segments mapped to a respective physical resource of the physical uplink shared channel. The operations of 1405 may be performed in accordance with examples as disclosed herein. In some examples, aspects of the operations of 1405 may be performed by a video frame component 625 as described with reference to FIG. 6.

At 1410, the method may include receiving, based on transmitting the set of multiple data segments, a segment feedback message associated with one or more data segments of the set of multiple data segments that were unsuccessfully decoded at the network entity, the segment feedback message indicating a predicted quantity of physical resources to successfully decode the one or more data segments at the network entity. The operations of 1410 may be performed in accordance with examples as disclosed herein. In some examples, aspects of the operations of 1410 may be performed by a segment feedback message component 635 as described with reference to FIG. 6.

At 1415, the method may include transmitting, via the physical uplink shared channel, a second set of multiple data segments including at least the one or more data segments via a second quantity of physical resources, the second quantity of physical resources being in accordance with the predicted quantity of physical resources. The operations of 1415 may be performed in accordance with examples as disclosed herein. In some examples, aspects of the operations of 1415 may be performed by a video frame component 625 as described with reference to FIG. 6.

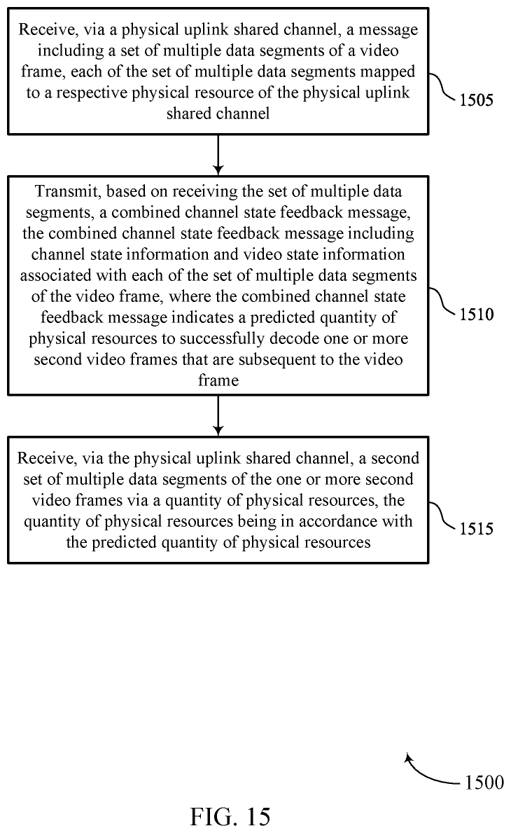

FIG. 15 shows a flowchart illustrating a method 1500 that supports enhanced signaling for DVC in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving, via a physical uplink shared channel, a message including a set of multiple data segments of a video frame, each of the set of multiple data segments mapped to a respective physical resource of the physical uplink shared channel. The operations of 1505 may be performed in accordance with examples as disclosed herein. In some examples, aspects of the operations of 1505 may be performed by a video frame reception component 1025 as described with reference to FIG. 10.

At 1510, the method may include transmitting, based on receiving the set of multiple data segments, a CCSF message, the CCSF message including CSI and video state information associated with each of the set of multiple data segments of the video frame, where the CCSF message indicates a predicted quantity of physical resources to successfully decode one or more second video frames that are subsequent to the video frame. The operations of 1510 may be performed in accordance with examples as disclosed herein. In some examples, aspects of the operations of 1510 may be performed by an CCSF transmission component 1030 as described with reference to FIG. 10.

At 1515, the method may include receiving, via the physical uplink shared channel, a second set of multiple data segments of the one or more second video frames via a quantity of physical resources, the quantity of physical resources being in accordance with the predicted quantity of physical resources. The operations of 1515 may be performed in accordance with examples as disclosed herein. In some examples, aspects of the operations of 1515 may be performed by a video frame reception component 1025 as described with reference to FIG. 10.

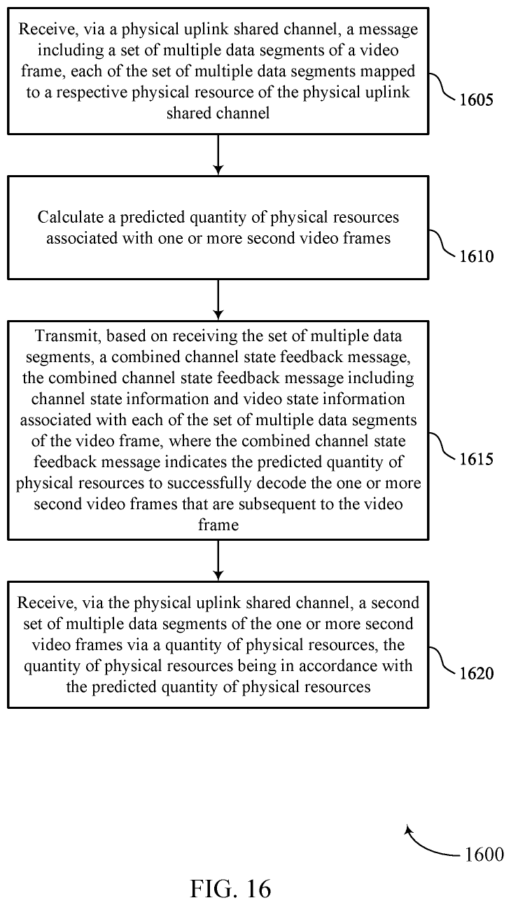

FIG. 16 shows a flowchart illustrating a method 1600 that supports enhanced signaling for DVC in accordance with aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include receiving, via a physical uplink shared channel, a message including a set of multiple data segments of a video frame, each of the set of multiple data segments mapped to a respective physical resource of the physical uplink shared channel. The operations of 1605 may be performed in accordance with examples as disclosed herein. In some examples, aspects of the operations of 1605 may be performed by a video frame reception component 1025 as described with reference to FIG. 10.

At 1610, the method may include calculating a predicted quantity of physical resources associated with one or more second video frames. The operations of 1610 may be performed in accordance with examples as disclosed herein. In some examples, aspects of the operations of 1610 may be performed by a physical resource calculation component 1045 as described with reference to FIG. 10.

At 1615, the method may include transmitting, based on receiving the set of multiple data segments, a CCSF message, the CCSF message including CSI and video state information associated with each of the set of multiple data segments of the video frame, where the CCSF message indicates the predicted quantity of physical resources to successfully decode one or more second video frames that are subsequent to the video frame. The operations of 1615 may be performed in accordance with examples as disclosed herein. In some examples, aspects of the operations of 1615 may be performed by an CCSF transmission component 1030 as described with reference to FIG. 10.

At 1620, the method may include receiving, via the physical uplink shared channel, a second set of multiple data segments of the one or more second video frames via a quantity of physical resources, the quantity of physical resources being in accordance with the predicted quantity of physical resources. The operations of 1620 may be performed in accordance with examples as disclosed herein. In some examples, aspects of the operations of 1620 may be performed by a video frame reception component 1025 as described with reference to FIG. 10.

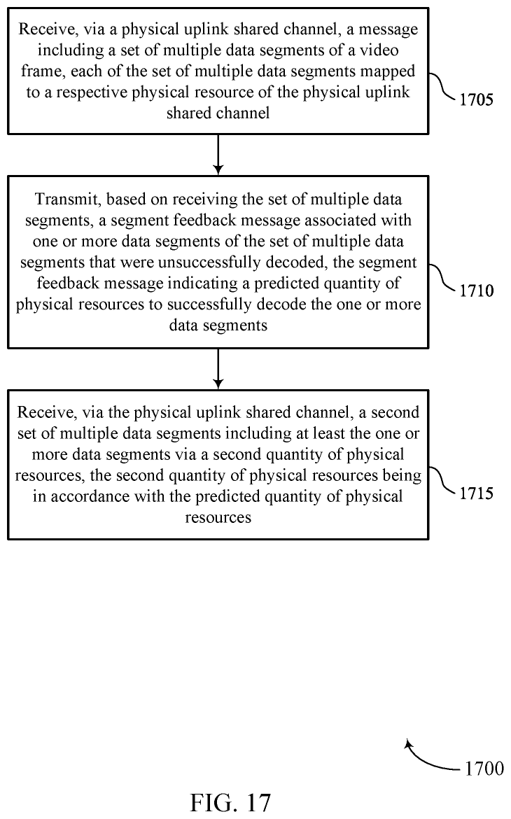

FIG. 17 shows a flowchart illustrating a method 1700 that supports enhanced signaling for DVC in accordance with aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include receiving, via a physical uplink shared channel, a message including a set of multiple data segments of a video frame, each of the set of multiple data segments mapped to a respective physical resource of the physical uplink shared channel. The operations of 1705 may be performed in accordance with examples as disclosed herein. In some examples, aspects of the operations of 1705 may be performed by a video frame reception component 1025 as described with reference to FIG. 10.

At 1710, the method may include transmitting, based on receiving the set of multiple data segments, a segment feedback message associated with one or more data segments of the set of multiple data segments that were unsuccessfully decoded, the segment feedback message indicating a predicted quantity of physical resources to successfully decode the one or more data segments. The operations of 1710 may be performed in accordance with examples as disclosed herein. In some examples, aspects of the operations of 1710 may be performed by a segment feedback transmission message component 1035 as described with reference to FIG. 10.

At 1715, the method may include receiving, via the physical uplink shared channel, a second set of multiple data segments including at least the one or more data segments via a second quantity of physical resources, the second quantity of physical resources being in accordance with the predicted quantity of physical resources. The operations of 1715 may be performed in accordance with examples as disclosed herein. In some examples, aspects of the operations of 1715 may be performed by a video frame reception component 1025 as described with reference to FIG. 10.

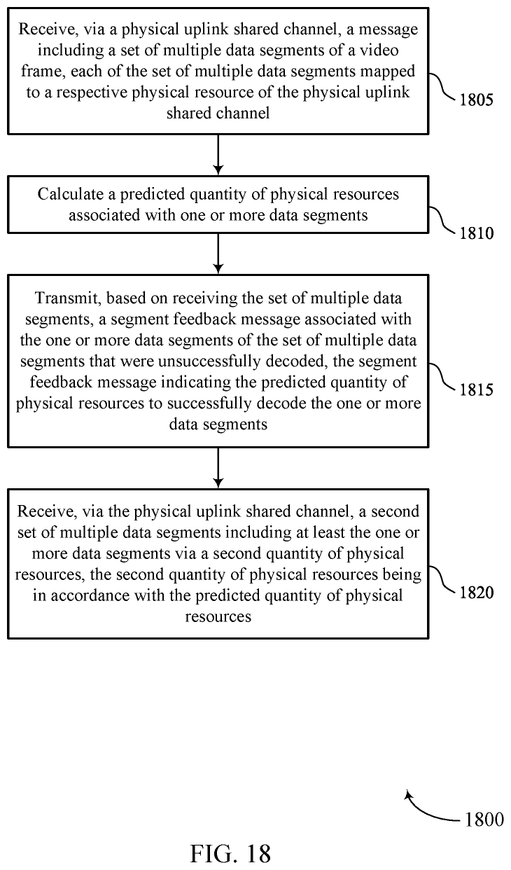

FIG. 18 shows a flowchart illustrating a method 1800 that supports enhanced signaling for DVC in accordance with aspects of the present disclosure. The operations of the method 1800 may be implemented by a network entity or its components as described herein. For example, the operations of the method 1800 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1805, the method may include receiving, via a physical uplink shared channel, a message including a set of multiple data segments of a video frame, each of the set of multiple data segments mapped to a respective physical resource of the physical uplink shared channel. The operations of 1805 may be performed in accordance with examples as disclosed herein. In some examples, aspects of the operations of 1805 may be performed by a video frame reception component 1025 as described with reference to FIG. 10.

At 1810, the method may include calculating a predicted quantity of physical resources associated with one or more data segments. The operations of 1810 may be performed in accordance with examples as disclosed herein. In some examples, aspects of the operations of 1810 may be performed by a physical resource calculation component 1045 as described with reference to FIG. 10.

At 1815, the method may include transmitting, based on receiving the set of multiple data segments, a segment feedback message associated with the one or more data segments of the set of multiple data segments that were unsuccessfully decoded, the segment feedback message indicating the predicted quantity of physical resources to successfully decode the one or more data segments. The operations of 1815 may be performed in accordance with examples as disclosed herein. In some examples, aspects of the operations of 1815 may be performed by a segment feedback transmission message component 1035 as described with reference to FIG. 10.

At 1820, the method may include receiving, via the physical uplink shared channel, a second set of multiple data segments including at least the one or more data segments via a second quantity of physical resources, the second quantity of physical resources being in accordance with the predicted quantity of physical resources. The operations of 1820 may be performed in accordance with examples as disclosed herein. In some examples, aspects of the operations of 1820 may be performed by a video frame reception component 1025 as described with reference to FIG. 10.

The following provides an overview of aspects of the present disclosure:

Aspect 1: A method for wireless communications at a UE, comprising: transmitting, via a PUSCH, a message comprising a plurality of data segments of a video frame, each of the plurality of data segments mapped to a respective physical resource of the PUSCH; receiving, based at least in part on transmitting the plurality of data segments, a CCSF message, the CCSF message comprising CSI and video state information associated with each of the plurality of data segments of the video frame, wherein the CCSF message indicates a predicted quantity of physical resources to successfully decode one or more second video frames, the one or more second video frames being subsequent to the video frame; and transmitting, via the PUSCH, a second plurality of data segments of the one or more second video frames via a quantity of physical resource, the quantity of physical resources being in accordance with the predicted quantity of physical resources.

Aspect 2: The method of aspect 1, further comprising: receiving, as part of the CSI of the CCSF message, an indication of one or more physical parameters associated with the predicted quantity of physical resources, wherein transmitting the second plurality of data segments is in accordance with the one or more physical parameters.

Aspect 3: The method of aspect 2, wherein the one or more physical parameters comprise a respective rank, a respective MCS, a respective precoding scheme, or a combination thereof for each physical resource of the predicted quantity of physical resources.

Aspect 4: The method of any of aspects 2 through 3, further comprising: adjusting the one or more physical parameters and one or more video coding parameters of the second plurality of data segments based at least in part on the CCSF message, wherein the second plurality of data segments are transmitted based at least in part on the adjusting.

Aspect 5: The method of any of aspects 1 through 4, wherein the CCSF message is received in accordance with a periodicity, semi-persistently, or a combination thereof.

Aspect 6: The method of any of aspects 1 through 5, wherein transmitting the plurality of data segments of the video frame and reception of the CCSF message is in accordance with a full duplex mode of operation.

Aspect 7: The method of claim 1, wherein each of the plurality of data segments is mapped to a respective code block.

Aspect 8: A method for wireless communications at a UE, comprising: transmitting, via a PUSCH, a message comprising plurality of data segments of a video frame to a network entity, each of the plurality of data segments mapped to a respective physical resource of the PUSCH; receiving, based at least in part on transmitting the plurality of data segments, a segment feedback message associated with one or more data segments of the plurality of data segments that were unsuccessfully decoded at the network entity, the segment feedback message indicating a predicted quantity of physical resources to successfully decode the one or more data segments at the network entity; and transmitting, via the PUSCH, a second plurality of data segments including at least the one or more data segments via a second quantity of physical resources, the second quantity of physical resources being in accordance with the predicted quantity of physical resources.

Aspect 9: The method of aspect 8, wherein the second quantity of physical resources is based at least in part on a difference between physical resources used for the plurality of data segments and the predicted quantity of physical resources, and the predicted quantity of physical resources is based at least in part on one or more channel conditions of the PUSCH and on video conditions of the video frame.

Aspect 10: The method of aspect 9, wherein a quantity of bits of the segment feedback message indicating the predicted quantity of physical resources satisfies a threshold quantity of bits.

Aspect 11: The method of any of aspects 8 through 10, wherein the segment feedback message is associated with a first data segment of the plurality of data segments.

Aspect 12: The method of any of aspects 8 through 11, wherein the segment feedback message is associated with a group of data segments of the plurality of data segments.

Aspect 13: The method of any of aspects 8 through 12, wherein the segment feedback message is associated with a code block of the PUSCH, the code block is associated with a subset of the one or more data segments.

Aspect 14: The method of any of aspects 8 through 13, wherein transmission the plurality of data segments of the video frame and reception of the segment feedback message is in accordance with a full duplex mode of operation.

Aspect 15: A method for wireless communications at a network entity, comprising: receiving, via a PUSCH, a message comprising a plurality of data segments of a video frame, each of the plurality of data segments mapped to a respective physical resource of the PUSCH; transmitting, based at least in part on receiving the plurality of data segments, a CCSF message, the CCSF message comprising CSI and video state information associated with each of the plurality of data segments of the video frame, wherein the CCSF message indicates a predicted quantity of physical resources to successfully decode one or more second video frames that are subsequent to the video frame; and receiving, via the PUSCH, a second plurality of data segments of the one or more second video frames via a quantity of physical resources, the quantity of physical resources being in accordance with the predicted quantity of physical resources.

Aspect 16: The method of aspect 15, further comprising: transmitting, as part of the CSI of the CCSF message, an indication of one or more physical parameters associated with the predicted quantity of physical resources, wherein receiving the second plurality of data segments is in accordance with the one or more physical parameters.

Aspect 17: The method of aspect 16, wherein the one or more physical parameters comprise a respective rank, a respective MCS, a respective precoding scheme, or a combination thereof for each physical resource of the predicted quantity of physical resources.

Aspect 18: The method of any of aspects 15 through 17, further comprising: calculating the predicted quantity of physical resources associated with the one or more second video frames, wherein the quantity of physical resources corresponds to the predicted quantity of physical resources.

Aspect 19: The method of any of aspects 15 through 18, further comprising: calculating first mutual information between respective parity bits of the message and respective transmitted parity bits of the message; calculating second mutual information between respective systematic bits of a plurality of predicted data segments and respective transmitted systematic bits of the plurality of data segments; and calculating a quantity of bits of the predicted quantity of physical resources for the plurality of predicted data segments based at least in part on the first mutual information, the second mutual information, a quantity of bits of each data segment of the plurality of data segments, or a combination thereof, wherein the predicted quantity of physical resources is based at least in part on the quantity of bits of the predicted quantity of physical resources.

Aspect 20: The method of any of aspects 15 through 19, wherein each of the plurality of data segments of the video frame is associated with a respective prediction quality based at least in part on a characteristic of the video frame, and the predicted quantity of physical resources is based at least in part on the respective prediction quality of each of the plurality of data segments.

Aspect 21: The method of any of aspects 15 through 20, wherein the CCSF message is transmitted in accordance with a periodicity, semi-persistently, or a combination thereof.

Aspect 22: The method of any of aspects 15 through 21, wherein receiving the plurality of data segments of the video frame and transmitting the CCSF message is in accordance with a full duplex communications mode.

Aspect 23: The method of claim 15, wherein the predicted quantity of physical resources are predicted via one or more machine learning models.

Aspect 24: The method of claim 15, wherein each of the plurality of data segments is mapped to a respective code block.

Aspect 25: A method for wireless communications at a network entity, comprising: receiving, via a PUSCH, a message comprising a plurality of data segments of a video frame, each of the plurality of data segments mapped to a respective physical resource of the PUSCH; transmitting, based at least in part on receiving the plurality of data segments, a segment feedback message associated with one or more data segments of the plurality of data segments that were unsuccessfully decoded, the segment feedback message indicating a predicted quantity of physical resources to successfully decode the one or more data segments; and receiving, via the PUSCH, a second plurality of data segments including at least the one or more data segments via a second quantity of physical resources, the second quantity of physical resources being in accordance with the predicted quantity of physical resources.

Aspect 26: The method of aspect 25, further comprising: determining one or more channel conditions of the PUSCH; and determining video conditions of the video frame, wherein the second quantity of physical resources is based at least in part on a difference between physical resources used for the plurality of data segments and the predicted quantity of physical resources, and wherein the predicted quantity of physical resources is based at least in part on the one or more channel conditions and the video conditions.

Aspect 27: The method of aspect 26, wherein a quantity of bits of the segment feedback message indicating the predicted quantity of physical resources satisfies a threshold quantity of bits.

Aspect 28: The method of any of aspects 25 through 27, further comprising: calculating the predicted quantity of physical resources associated with the one or more data segments.

Aspect 29: The method of any of aspects 25 through 28, further comprising: calculating first mutual information between respective parity bits of the message and respective transmitted parity bits of the message; calculating second mutual information between respective systemic bits of a plurality of predicted data segments and respective transmitted systematic bits of the one or more data segments; and calculating a quantity of bits of the predicted quantity of physical resources based at least in part on the first mutual information, the second mutual information, a quantity of bits of each data segment of the one or more data segments, or a combination thereof, wherein the predicted quantity of physical resources is based at least in part on the quantity of bits of the predicted quantity of physical resources.

Aspect 30: The method of any of aspects 25 through 29, wherein the segment feedback message is associated with a first data segment of the plurality of data segments.

Aspect 31: The method of any of aspects 25 through 30, wherein the segment feedback message is associated with a group of data segments of the plurality of data segments.

Aspect 32: The method of any of aspects 25 through 31, wherein the segment feedback message is associated with a code block of the PUSCH, the code block is associated with a subset of the one or more data segments.

Aspect 33: The method of any of aspects 25 through 32, wherein reception of the plurality of data segments of the video frame and transmission of the segment feedback message is in accordance with a full duplex mode of operation.

Aspect 34: The method of any of aspects 25 through 33, wherein the predicted quantity of physical resources are predicted based at least in part on one or more machine learning models.

Aspect 35: A UE for wireless communication, comprising: one or more memories storing processor-executable code; one or more processors coupled with the one or more memories and individually or collectively operable to execute the code to cause the UE to perform a method of any of aspects 1 through 7.

Aspect 36: A UE for wireless communication, comprising at least one means for performing a method of any of aspects 1 through 7.

Aspect 37: A non-transitory computer-readable medium storing code for wireless communications, the code comprising instructions executable by one or more processors to perform a method of any of aspects 1 through 7.

Aspect 38: A UE for wireless communication, comprising: one or more memories storing processor-executable code; one or more processors coupled with the one or more memories and individually or collectively operable to execute the code to cause the UE to perform a method of any of aspects 8 through 14.

Aspect 39: A UE for wireless communication, comprising at least one means for performing a method of any of aspects 8 through 14.

Aspect 40: A non-transitory computer-readable medium storing code for wireless communications, the code comprising instructions executable by one or more processors to perform a method of any of aspects 8 through 14.

Aspect 41: A network entity for wireless communication, comprising: one or more memories storing processor-executable code; one or more processors coupled with the one or more memories and individually or collectively operable to execute the code to cause the network entity to perform a method of any of aspects 15 through 24.

Aspect 42: A network entity for wireless communication, comprising at least one means for performing a method of any of aspects 15 through 24.

Aspect 43: A non-transitory computer-readable medium storing code for wireless communications, the code comprising instructions executable by one or more processors to perform a method of any of aspects 15 through 24.

Aspect 44: A network entity for wireless communication, comprising: one or more memories storing processor-executable code; one or more processors coupled with the one or more memories and individually or collectively operable to execute the code to cause the network entity to perform a method of any of aspects 25 through 34.

Aspect 45: A network entity for wireless communication, comprising at least one means for performing a method of any of aspects 25 through 34.

Aspect 46: A non-transitory computer-readable medium storing code for wireless communications, the code comprising instructions executable by one or more processors to perform a method of any of aspects 25 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories storing processor-executable code; and
one or more processors coupled with the one or more memories and individually or collectively operable to execute the code to cause the UE to:
transmit, via a physical uplink shared channel, a message comprising a plurality of data segments of a video frame, each of the plurality of data segments mapped to a respective physical resource of the physical uplink shared channel;
receive, based at least in part on transmitting the plurality of data segments, a combined channel state feedback message, the combined channel state feedback message comprising channel state information and video state information associated with each of the plurality of data segments of the video frame, wherein the combined channel state feedback message indicates a predicted quantity of physical resources to successfully decode one or more second video frames, the one or more second video frames being subsequent to the video frame; and
transmit, via the physical uplink shared channel, a second plurality of data segments of the one or more second video frames via a quantity of physical resource, the quantity of physical resources being in accordance with the predicted quantity of physical resources.

2. The UE of claim 1, wherein the one or more processors are individually or collectively further operable to execute the code to cause the UE to:
receive, as part of the channel state information of the combined channel state feedback message, an indication of one or more physical parameters associated with the predicted quantity of physical resources, wherein transmitting the second plurality of data segments is in accordance with the one or more physical parameters.

3. The UE of claim 2, wherein the one or more physical parameters comprise a respective rank, a respective modulation and coding scheme, a respective precoding scheme, or a combination thereof for each physical resource of the predicted quantity of physical resources.

4. The UE of claim 2, wherein the one or more processors are individually or collectively further operable to execute the code to cause the UE to:
adjust the one or more physical parameters and one or more video coding parameters of the second plurality of data segments based at least in part on the combined channel state feedback message, wherein the second plurality of data segments are transmitted based at least in part on the adjusting.

5. The UE of claim 1, wherein the combined channel state feedback message is received in accordance with a periodicity, semi-persistently, or a combination thereof.

6. The UE of claim 1, wherein transmitting the plurality of data segments of the video frame and reception of the combined channel state feedback message is in accordance with a full duplex mode of operation.

7. The UE of claim 1, wherein each of the plurality of data segments is mapped to a respective code block.

8. A user equipment (UE) for wireless communication, comprising:
one or more memories storing processor-executable code; and
one or more processors coupled with the one or more memories and individually or collectively operable to execute the code to cause the UE to:
transmit, via a physical uplink shared channel, a message comprising plurality of data segments of a video frame to a network entity, each of the plurality of data segments mapped to a respective physical resource of the physical uplink shared channel;
receive, based at least in part on transmitting the plurality of data segments, a segment feedback message associated with one or more data segments of the plurality of data segments that were unsuccessfully decoded at the network entity, the segment feedback message indicating a predicted quantity of physical resources to successfully decode the one or more data segments at the network entity; and
transmit, via the physical uplink shared channel, a second plurality of data segments including at least the one or more data segments via a second quantity of physical resources, the second quantity of physical resources being in accordance with the predicted quantity of physical resources.

9. The UE of claim 8, wherein:
the second quantity of physical resources is based at least in part on a difference between physical resources used for the plurality of data segments and the predicted quantity of physical resources, and
the predicted quantity of physical resources is based at least in part on one or more channel conditions of the physical uplink shared channel and on video conditions of the video frame.

10. The UE of claim 9, wherein a quantity of bits of the segment feedback message indicating the predicted quantity of physical resources satisfies a threshold quantity of bits.

11. The UE of claim 8, wherein the segment feedback message is associated with a first data segment of the plurality of data segments.

12. The UE of claim 8, wherein the segment feedback message is associated with a group of data segments of the plurality of data segments.

13. The UE of claim 8, wherein the segment feedback message is associated with a code block of the physical uplink shared channel, and the code block is associated with a subset of the one or more data segments.

14. The UE of claim 8, wherein transmission the plurality of data segments of the video frame and reception of the segment feedback message is in accordance with a full duplex mode of operation.

15. A network entity for wireless communication, comprising:
one or more memories storing processor-executable code; and
one or more processors coupled with the one or more memories and individually or collectively operable to execute the code to cause the network entity to:
receive, via a physical uplink shared channel, a message comprising a plurality of data segments of a video frame, each of the plurality of data segments mapped to a respective physical resource of the physical uplink shared channel;
transmit, based at least in part on receiving the plurality of data segments, a combined channel state feedback message, the combined channel state feedback message comprising channel state information and video state information associated with each of the plurality of data segments of the video frame, wherein the combined channel state feedback message indicates a predicted quantity of physical resources to successfully decode one or more second video frames that are subsequent to the video frame; and
receive, via the physical uplink shared channel, a second plurality of data segments of the one or more second video frames via a quantity of physical resources, the quantity of physical resources being in accordance with the predicted quantity of physical resources.

16. The network entity of claim 15, wherein the one or more processors are individually or collectively further operable to execute the code to cause the network entity to:
transmit, as part of the channel state information of the combined channel state feedback message, an indication of one or more physical parameters associated with the predicted quantity of physical resources, wherein receiving the second plurality of data segments is in accordance with the one or more physical parameters.

17. The network entity of claim 16, wherein the one or more physical parameters comprise a respective rank, a respective modulation and coding scheme, a respective precoding scheme, or a combination thereof for each physical resource of the predicted quantity of physical resources.

18. The network entity of claim 15, wherein the one or more processors are individually or collectively further operable to execute the code to cause the network entity to:
calculate the predicted quantity of physical resources associated with the one or more second video frames, wherein the quantity of physical resources corresponds to the predicted quantity of physical resources.

19. The network entity of claim 15, wherein the one or more processors are individually or collectively further operable to execute the code to cause the network entity to:
calculate first mutual information between respective parity bits of the message and respective transmitted parity bits of the message;
calculate second mutual information between respective systematic bits of a plurality of predicted data segments and respective transmitted systematic bits of the plurality of data segments; and
calculate a quantity of bits of the predicted quantity of physical resources for the plurality of predicted data segments based at least in part on the first mutual information, the second mutual information, a quantity of bits of each data segment of the plurality of data segments, or a combination thereof, wherein the predicted quantity of physical resources is based at least in part on the quantity of bits of the predicted quantity of physical resources.

20. The network entity of claim 15, wherein each of the plurality of data segments of the video frame is associated with a respective prediction quality based at least in part on a characteristic of the video frame, and the predicted quantity of physical resources is based at least in part on the respective prediction quality of each of the plurality of data segments.

21. The network entity of claim 15, wherein the combined channel state feedback message is transmitted in accordance with a periodicity, semi-persistently, or a combination thereof.

22. The network entity of claim 15, wherein receiving the plurality of data segments of the video frame and transmitting the combined channel state feedback message is in accordance with a full duplex communications mode.

23. The network entity of claim 15, wherein:
the predicted quantity of physical resources are predicted via one or more machine learning models.

24. The network entity of claim 15, wherein each of the plurality of data segments is mapped to a respective code block.

25. A network entity for wireless communication, comprising:
one or more memories storing processor-executable code; and
one or more processors coupled with the one or more memories and individually or collectively operable to execute the code to cause the network entity to:
receive, via a physical uplink shared channel, a message comprising a plurality of data segments of a video frame, each of the plurality of data segments mapped to a respective physical resource of the physical uplink shared channel;
transmit, based at least in part on receiving the plurality of data segments, a segment feedback message associated with one or more data segments of the plurality of data segments that were unsuccessfully decoded, the segment feedback message indicating a predicted quantity of physical resources to successfully decode the one or more data segments; and
receive, via the physical uplink shared channel, a second plurality of data segments including at least the one or more data segments via a second quantity of physical resources, the second quantity of physical resources being in accordance with the predicted quantity of physical resources.

26. The network entity of claim 25, wherein the one or more processors are individually or collectively further operable to execute the code to cause the network entity to:
determine one or more channel conditions of the physical uplink shared channel; and
determine video conditions of the video frame, wherein the second quantity of physical resources is based at least in part on a difference between physical resources used for the plurality of data segments and the predicted quantity of physical resources, and wherein the predicted quantity of physical resources is based at least in part on the one or more channel conditions and the video conditions.

27. The network entity of claim 26, wherein a quantity of bits of the segment feedback message indicating the predicted quantity of physical resources satisfies a threshold quantity of bits.

28. The network entity of claim 25, wherein the one or more processors are individually or collectively further operable to execute the code to cause the network entity to:
calculate the predicted quantity of physical resources associated with the one or more data segments.

29. The network entity of claim 25, wherein the one or more processors are individually or collectively further operable to execute the code to cause the network entity to:
calculate first mutual information between respective parity bits of the message and respective transmitted parity bits of the message;
calculate second mutual information between respective systemic bits of a plurality of predicted data segments and respective transmitted systematic bits of the one or more data segments; and
calculate a quantity of bits of the predicted quantity of physical resources based at least in part on the first mutual information, the second mutual information, a quantity of bits of each data segment of the one or more data segments, or a combination thereof, wherein the predicted quantity of physical resources is based at least in part on the quantity of bits of the predicted quantity of physical resources.

30. The network entity of claim 25, wherein the predicted quantity of physical resources are predicted based at least in part on one or more machine learning models.
